(19) United States
(12) Patent Application Publication
(10) Pub. No.: US 2002/0095387 A1
(43) Pub. Date: Jul. 18, 2002

(54) Online content portal system

(76) Inventors: Bertrand Sosa, Austin, TX (US); Rogelio Sosa, Austin, TX (US)

Correspondence Address: Gary R. Stanford, Law Offices of Gary R. Stanford, 610 West Lynn, Austin, TX, 78703, US

(21) Appl. No.: 10/097,170

(22) Filed: Mar. 13, 2002

Related U.S. Application Data
(63) Continuation-in-part of application No. 09/661,724, filed on Sep. 14, 2000.
(63) Continuation-in-part of application No. 09/493,886, filed on Jan. 28, 2000.
(63) Continuation-in-part of application No. 09/384,581, filed on Aug. 27, 1999.
(60) Provisional application No. 60/277,688, filed on Mar. 21, 2001.

(51) Int. Cl. G06F 17/60

(52) U.S. Cl. 705/65

(57) ABSTRACT

A system and method of providing an online content portal for sending affiliate content to users of an online account system via the Internet. An online content portal is provided with each user cash account for sending affiliate content. Users conduct purchase transactions with third parties via the Internet using online cash account funds. The system is configured to provide valid charge numbers acceptable to the third parties to consummate the purchase transactions. The charge numbers are similar to standard credit card numbers and universally accepted, where the system is also configured to be the processor of such charge numbers. The shopping and purchase activity of users is monitored and stored along with account information in a user information database. Affiliates may download and/or search the user information database to target users for sending the affiliate content. The online content portal system facilitates collection of valuable user information and identification of users to receive selected types of content.

### CROSS-REFERENCE TO RELATED APPLICATION(S)

The present application is based on U.S. Provisional Application entitled “An Online Content Portal System”, Serial No. 60/277,688, filed Mar. 21, 2002, which is hereby incorporated by reference in its entirety. The present application is also a continuation-in-part of U.S. patent application entitled “A Transaction System And Method Using Cash Cards And A Charge Settlement Network”, Ser. No. 09/661,724, filed Sep. 14, 2000, which itself is a continuation-in-part of U.S. patent application entitled “An Online Purchase System And Method”, Ser. No. 09/493,886, filed Jan. 28, 2000, which itself is a continuation-in-part of U.S. patent application entitled “Prepaid Card Based Internet and Merchandiser Sales and Advertising System”, Ser. No. 09/384,581, filed Aug. 27, 1999, all of which are incorporated herein by reference in their entirety and made part of the present application.

1. Field of the Invention

The present invention relates to e-commerce, and more particularly, to a online content portal system and method that provides a method of enabling purchase transactions employing cash accounts in exchange for online portals for marketing and the like.

2. Description of Related Art

The explosion of the Internet has led to new methods of doing business generally referred to as electronic commerce or “e-commerce”. E-commerce has become fairly common and involves many types of online transactions over an electronic communications network, such as the Internet or any other global network, including business-to-business, business-to-consumer, business-to-government and similar type transactions. Consumers can shop for and purchase goods and services online without leaving the home or the computer. In the consumer world, the primary method of conducting purchases is the use of a credit or debit card, otherwise referred to as a charge card. The consumer provides the charge number and expiration date and any other information that may be required such as name and address, etc. on a purchase page from an online merchant. The online merchant clears or verifies the charge information, either during the immediate transaction or at a later time, and settles the purchase upon verification. For example, the merchant may settle the transaction via a charge settlement network, such as the electronic funds transfer (EFT) network or the automated clearinghouse (ACH) network or the like. The ACH network is a nationwide payment and collection system that provides for the electronic distribution and settlement of funds.

Other billing methods have been used such as mail delivery or cash on delivery (COD), but these other methods are more costly and are certainly not as convenient for both merchants and consumers. Methods of billing by mail or COD are limited and are not satisfactory for various reasons, including lack of convenience and potential lack of anonymity. The e-wallet technique is becoming more popular, but is still credit-based and requires a valid charge account.

There are many people who choose not to have a charge card for various reasons yet desire the convenience that credit cards offer. There are many people who are unable to obtain a charge card, such as under-aged individuals or those with poor credit or financial histories. There are many people who have credit cards but want their credit numbers and their personal information to remain confidential, and yet still desire the convenience of ecommerce. The use of a charge card precludes anonymity and confidentiality since the merchant verifies the account through the sponsor of the charge card and therefore has access to the identity of the purchaser. There are many people who are concerned, for good reason, that online use of a personal charge or credit number may not be secure. Cybertheft continues to pose a significant threat to online merchants and e-commerce in general. Unauthorized intruders often breach the security measures of a web site and steal otherwise valid credit card information. Such compromised credit accounts may be used to conduct illicit and unauthorized purchase transactions resulting in increased cost to merchants and consumers. Although security measures are improving, hackers are often one step ahead and continue to impede the full potential of e-commerce.

Online cash card systems have been attempted but have not been overly successful for a variety of reasons. A significant problem has been providing availability of cash cards and motivating customer sale. A potential solution is to sell cash cards at existing brick and mortar merchants that serve as distributors of the cash cards to the public, such as grocery stores, music stores, video stores, movie houses, gasoline stations, coffee shops, restaurants, convenience stores, drug stores, malls, clothing stores, jewelry stores, or any other retail establishment. Such potential distributors have physical store fronts with goods and services already on sale to the public to therefore provide a ready stream of potential users of online cash cards. These potential distributors also have an infrastructure established for marketing and selling the cash cards, including wall and counter space and clerks or cashiers to conduct sales.

A problem of employing established merchants as distributors is providing motivation for selling the cash cards. One motivational method that has been tried is a discount model in which affiliated online merchants offer discounts for use of the card for online purchase transactions and in which the distributor is paid a percentage of the sale of each card. For example, the distributor is paid $2 for selling a $10 cash card, and the affiliated online merchants offer $10 of goods or services at a discounted price of $8. The discount method is severely limited in that only the affiliated online merchants honor that cash card, so that the card is not universally accepted. Also, there are little or no funds left for the sponsor of the cash card, which must rely on other means of revenue. Another motivational method is the premium model, in which the user pays a premium for the cash card, such as, for example, $12 for a $10 cash card. The premium model is not favored by users. Also, the premium model is typically credit or credit-card based, thereby eliminating any potential benefits of a cash-based system as compared to creditbased systems.

It is desired to provide the convenience of charge cards for conducting purchases over the Internet or a telephonic network to those people who have the necessary funds or cash but who cannot or would rather not use charge cards. It is further desired to maintain or even enhance cash management convenience afforded by debit cards and automated teller machines (ATM). It is further desired to improve security of purchase transactions, including online and/or telephonic transactions, and reduce or otherwise eliminate the potential of credit theft and fraud and to provide worry-free e-commerce.

### SUMMARY OF THE INVENTION

A method of providing an online content portal for sending affiliate content to at least one user of an online account system via an electronic communications network according to the present invention includes providing a content portal with each of at least one online cash account for sending affiliate content to corresponding one or more users. The method further includes providing an online cash account for each user of the online account system, and enabling each user to conduct purchase transactions with third parties via the electronic communications network using funds in their online cash accounts, where the online account system configured to provide valid charge numbers acceptable to the third parties to consummate the purchase transactions. The method further includes monitoring activity of users employing corresponding online cash accounts, such activity including shopping and purchase behavior of the users with the third parties, and storing a user information database that includes account and activity information of each user. The electronic communications network may include or otherwise incorporate the Internet.

An affiliate is any business entity who desires to become affiliated with the cash account system in exchange for payment, goods or services. For example, a distributor merchant may become an affiliate in exchange for selling cash cards to its customers, who then become users of the online cash account system. A business entity may become an affiliate by conducting a promotional, marketing or advertising scheme or the like that informs its users, customers, potential customers or the general public about the cash account system in such a manner that brings potential users to the cash account system. An affiliate may be any introducer, merchant or vendor, including distributors, e-merchants conducting online sales and transactions, traditional brick and mortar merchants, etc., that may have an interest in using or accessing the online content portal system available through the cash account system to its users. A business entity that is not already an affiliate may become an affiliate through one or more affiliate programs or the like, where the potential affiliate applies and signs an appropriate agreement and pays any associated fees depending upon the level of service desired.

It is appreciated that the valid charge numbers are universally accepted by any merchant configured to accept standard charge card numbers, such as those conforming to Visa, Mastercard, Discover Card, and the like. In this manner, users may establish pre-paid cash accounts with the online account system and shop anywhere as though they had a standard credit card. Meanwhile, the shopping and purchase behavior of the users is monitored and tracked and corresponding activity information is stored. A content portal is established with each user for sending that user content. The method may further include maintaining confidentiality of personal information of at least one of the users. Any user may choose to remain anonymous, although the anonymous user's activity is nonetheless still tracked and stored and the user may still be reached via the an online content portal.

The method may further include providing the affiliate content to at least one selected user via corresponding content portals. In one embodiment, the method may include incorporating a link into the content portal indicative of the location of the affiliate content, and providing, from the indicated location, the affiliate content to one or more users via corresponding content portals. In this manner, the online cash account system need not store or otherwise contain the affiliate content, but provides the information to access the content to be delivered to the users. The online cash account system acts as a “broker” of the information without being the direct provider of such affiliate content. In an alternative embodiment, the online cash account system receives and locally stores the affiliate content and delivers the content to selected users as further described below.

The affiliate may be a distributor of cash cards, so that the method may further include providing a cash card that may be used by an existing user or a new user to establish or replenish an online cash account via the electronic communications network. The method may further include enabling the cash card for offline financial transactions using funds in an online cash account, where the monitoring includes tracking online and offline activity of a user. The tracked activity may be stored in a user information database or the like. In yet further embodiments, the distributor may be a promoter or the like of a promotional scheme, where the method may further include linking the promoter with the cash card, distributing the cash card for free in association with the promotional scheme, and establishing a promotional online cash account for a user receiving the cash card.

The affiliate may be a distributor merchant, such as a traditional brick and mortar establishment or the like, that distributes cash cards by offering them for sale. The method may further include providing, by such distributers, a cash card that incorporates a corresponding serial number that may be used to establish a new online cash account or replenish an existing online cash account via the electronic communications network. The method may further include linking an online cash account with a purchased cash card, determining locality information of the distributor merchant that sold the cash card, and storing the locality information in the user information database. The method may include a distributor merchant selling cash cards, associating the distributor merchant with an online cash account that corresponds to the cash card that was sold, and sending, by the distributor merchant via the online account system, affiliate content to a user that purchased the cash card via a content portal of the associated online cash account. Such affiliate content may be sent directly from the online cash account system or indirectly via a link or the like. The affiliate content may be, for example, advertising content and the like intended to provide incentive to the user to return to that particular distributor merchant. In general, the affiliate content may include at least one of advertising information, marketing information branding information, discount information, coupon information and promotional information. Many ways are available for identifying the distributer merchant that sold a particular cash card. In one embodiment, for example, the method may include validating a purchased cash card via a charge settlement network, and identifying the distributor merchant via the charge settlement network.

Branding information associated with the distributor merchant may be provided on a surface of the cash card. The method may further include associating a distributor merchant with an online cash account that corresponds to the cash card that was sold, where the content portal includes displaying a virtual card with brand information of the distributor merchant. The virtual card is displayed to the user that purchased the cash card while that user accesses their associated online cash account. The virtual card may be similar or identical to the physical card sold to the user.

The method may further include receiving at least one token from an affiliate, publishing the token, detecting access by an existing or potential user of the online account system that identifies the affiliate and a token, and linking the user with an online cash account associated with the affiliate. The token may be any alphanumeric digital value, such as a serial number including a manufacturer's serial number (MSN) or the like, or a codeword, or a barcode, or any type of symbol or the like. The token may by published by any one of several different means, such as by printing the token directly on product packaging manufactured or distributed by the affiliate, or by announcing the token via a public media, or by associating the token with a service of the affiliate, etc. The method may further include detecting a user accessing the online account system via a website associated with the affiliate, and receiving affiliate identification information in conjunction with the user access.

The method may incorporate a means by which affiliates can identify or otherwise determine users of choice for receiving certain types of affiliate content. The method may include, for example, searching one or more cash accounts employing the user information database, and enabling affiliate content to be provided for display to at least one selected user via a content portal of a corresponding online cash account. The method may include downloading information from the user information database by the affiliate. In this manner, the affiliate may have a search utility or the like configured to search downloaded information of the users, such as account information and activity information or the like. Such downloading by the affiliate alleviates the online cash account system from having to supply the requisite processing power to conduct the searches of the user information base. Alternatively, the online cash account system may include such processing capabilities and search utilities, where the method may include receiving a search request from the affiliate, and providing the search results in any of several different formats in accordance with the affiliate search request, such as a list including at least one cash account, a profile list including at least one user behavioral profile in accordance with the affiliate search request, a research report based on aggregate profile information of users, etc.

The method may further include associating at least one user with an affiliate, and displaying a virtual card with a valid charge number and brand information of the affiliate to the user. The virtual card may be configured with interactive capabilities. Alternatively, or in addition, the virtual card may operate as a video portal, so that a video may be displayed through the virtual credit card video portal.

An online content portal system for displaying content to selected users via a computer communications network according to embodiments of the present invention includes a computer network communication system that interfaces and enables communications via the computer communications network, a memory that stores a user information database including shopping and purchase activity and online cash account information, a transaction and account system that facilitates purchase transactions by providing valid charge numbers acceptable to third parties for consummating purchase transactions and that maintains online cash account information in the memory, a tracking utility that monitors shopping and purchase activity associated with each online cash account and that updates and maintains the user information database, and a display utility that enables access to affiliate content for display via selected online cash accounts when the selected online cash accounts are accessed via the computer communications network.

The online content portal system may include a search utility that is configured to receive user information requests and to provide content from the user information database in response to the request. The search utility may output a list of online cash accounts that meet a search request, or a list of user profiles that meet a search request. The content portal system may include a profile generator that generates user behavioral profiles based on shopping and purchase activity and online cash account information. The profile generator may be configured to maintain a profile database that stores a user behavioral profile associated with each user. The search utility, if provided, may further be configured to receive queries, to search the profile database, and to select online cash accounts that meet each query. The search utility may outputs a list of online cash accounts that meet a query, a list of user behavioral profiles that meet a query, etc. The content portal system may include a report generator that is configured to generate marketing reports based on user information in the user information database. Such marketing reports may be based on user behavioral profiles, or based on aggregate information of multiple user behavioral profiles. The marketing reports may be stored in a report database or generated and distribute when created.

In alternative embodiments, the tracking utility or the transaction and account system or a combination of both may be configured to download information from the user information database in response to a user information request by an affiliate. The downloaded information may include the entire contents or selected portions of the user information database. The affiliate receiving the information may conduct any desired searches on the downloaded information to identify target users. Alternatively or in addition, the online content portal system may include a server search utility that is configured to cooperate with a client utility via the computer communications network to download information from the user information database. The client utility may be located, for example, on an affiliate server or the like. In this configuration, the server search utility does not necessarily conduct intensive searches of the database, but instead retrieves all or selected portions of the database as dictated by the client utility. Thus, much of the processing is offloaded to a remote site, such as provided by the affiliate.

The online content portal system may include a user content display information list that identifies affiliate content associated with each online cash account, where the display utility is configured to provide a location link to the affiliate content indicating a location via the computer communications network. Such linking capability enables the affiliate content to be stored remotely, such as on an affiliate server or any third party content provider's server or the like. Alternatively, the memory may store an affiliate database including affiliate content from at least one affiliate. The transaction and account system may be configured to parse affiliate content from the affiliate database for each online cash account. The content portal system may include a web page database that stores template and predetermined web page information, where the display utility operates to retrieve selected web pages from the web page database and to populate template web pages with affiliate content from the user content display information list or the like.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram illustrating an exemplary embodiment of charge number distribution from an issuing or sponsoring bank and corresponding application.

FIG. 2 is a block diagram illustrating an exemplary cash card provided or otherwise encoded with a selected card number.

FIG. 3 is a block diagram of an exemplary charge number issuing and processing system illustrating usage of cash cards for performing transactions including financial transactions.

FIG. 4 is a flow chart diagram illustrating activation and operation of the charge number issuing and processing system of FIG. 3.

FIG. 5 is a block diagram illustrating exemplary use of cash cards in association with cash accounts through the cash account system of FIG. 1.

FIG. 6 is a block diagram illustrating an online purchase transaction by a user using the cash account system via the computer communications network to request a valid purchase number.

FIG. 7 is a block diagram illustrating a request by a user from the cash account system via the telephonic network to request a valid purchase number and to conduct a purchase transaction with a merchant using the provided valid charge information via the telephonic network.

FIG. 8 is a screen shot of an exemplary web page that may be displayed to a user when accessing their associated prepaid cash account.

FIG. 9 is a block diagram of a promotion system utilizing the cash account system of FIG. 1 with the account database of FIG. 3.

FIG. 10A is a graphic diagram of an exemplary cash card that is purchased at a distributor merchant.

FIG. 10B is diagram of an exemplary virtual card, which is a graphic representation displayed on the user's monitor or screen with a graphic surface that may include similar information as the physical cash card of FIG. 10A.

FIG. 11 is a block diagram of the cash account system more fully illustrating an online content portal system in accordance with embodiments of the present invention.

FIG. 12 is a screen shot of an exemplary web page that appears during an online session when a user is logged into the cash account system of FIG. 1.

FIG. 13 is a block diagram illustrating an alternative embodiment in which the affiliate content is provided directly to a user from a particular affiliate.

FIG. 14 is a block diagram illustrating another alternative embodiment in which the affiliate content is provided directly to a user from a third party content provider rather than from the particular affiliate or the online cash account system.

FIG. 15 is a block diagram illustrating another alternative embodiment in which the affiliate (or a third party provider) includes an appropriate search program or utility to offload some or all of the database search-related processing conducted by the online cash account system.

FIG. 16 is a block diagram illustrating another alternative embodiment in which the affiliate (or a third party provider) includes a client search utility to offload some or all of the database search-related processing conducted by the online cash account system.

### DETAILED DESCRIPTION OF EMBODIMENT(S) OF THE INVENTION

The term “computer communications network” is generally used herein to refer to networks established between computers or the like, such as a local area network (LAN), a wide area network (WAN), etc., and further encompasses the interconnection or intercoupling of such networks such as comprises the Internet including the Internet backbone and other networks that enable global computer communications. Although the Internet is often thought of as a public network, it also encompasses private networks and Virtual Private Networks (VPN) configured within a public network. Computer communications network also encompasses “in-house” LANs or web sites within a company or the like, and extranets open to customers and the like. The term “computer communications network” also incorporates wireless technology, such as wireless LANs (WLAN), wireless modems, and any other wireless extensions of computer related networks.

The term “telephonic network” generally contemplates the telephone industry and technology in general including the Public Switched Telephone Network (PSTN) and other similar type networks and technology. The telephonic network includes communications between phones, phone systems, facsimile machines, modems, computers, pagers, cellular telephones, etc. As described further below, the term telephonic network also encompasses wireless and cellular telephony and technology and related concepts.

It is further recognized that there is significant overlap in the concepts of computer communications networks and telephonic networks, such as, for example, connection to the Internet via a telephonic modem or the like. Also, much of the Internet is implemented using telephonic networks throughout the world. The term “electronic communications network” contemplates any public and/or private communications network that enables communication between people or devices over a broad area and even worldwide, such as the Internet or the like, and is intended to encompass both computer communications and telephonic networks and related concepts and technology. The term “online” generally connotes communication activities utilizing a computer communications network, such as, for example, utilizing a computer with browser software or the like via the Internet, but also encompasses similar activities utilizing the telephonic network and telephonic devices. The term “electronic communications network” also encompasses all related wireless communications concepts associated with computer communications networks and telephonic networks and otherwise.

The term “charge settlement network” refers to any system or network that is employed by online and/or brick and mortar merchants or the like to authorize, clear, settle, etc. transactions being conducted in association with charge numbers, such as standard debit or credit numbers provided on charge cards. A charge settlement network enables any transfer of funds initiated through an electronic terminal, telephone, computer or magnetic tape, and transfers made at automated teller machines (ATM) and point-of-sale (POS) terminals. For example, brick and mortar merchants typically include a validation unit or card reader or the like for reading encoded charge numbers on magnetic strips on charge cards or the like. The charge card is swiped in the card reader during a purchase transaction or the like, where the card reader reads and forwards the retrieved charge number to an authorized or certified processor for the charge number to clear and/or settle the transaction. Online merchants transmit valid charge numbers electronically to a charge settlement network to clear transactions. A charge number may also be conveyed over a telephonic network to consummate a transaction, where the receiving merchant verifies the number via a charge settlement network to clear the transaction. The term “charge settlement network” encompasses any existing electronic networks, such as the Electronic Funds Transfer (EFT) network, the Automated Clearing House (ACH) network, etc. The ACH network is a nationwide payment and collection system that provides for the electronic distribution and settlement of funds. It is noted that a charge settlement network is often viewed as a private network. It is understood, however, that a charge settlement network may be implemented on any type of electronic communications network including computer communications and telephonic networks.

In prior disclosures, an online cash account system was disclosed that enables consumers to purchase goods and services online via an electronic communications network, such as the Internet or the like. The prior disclosure is hereby incorporated by reference in its entirety and is briefly summarized herein. The online cash account system provides a universally accessible, anonymous and secure online payment option for users of the system. In general, a user purchases a cash card or the like from a receiving entity, such as an automated dispensing unit (ADI) with a validation unit, a clerk at a brick and mortar merchant, etc. The cash card is validated with a serial number at the receiving entity, where the validated cash card further enabled online activation of an online cash account with the cash account system.

The user establishes an online session with the cash account system, such as by entering a web address of the cash account system via a web browser or the like on the Internet, and the user then enters the serial number. The cash account system verifies the serial number and establishes an online cash account for the user with a cash balance in accordance with the amount of cash provided to the receiving entity. The user provides a user ID and password enabling subsequent access and usage of the cash account. Additional cash cards may be purchased to further fund existing accounts or to create new accounts. The user surfs a computer communications network, such as the Internet or the like, shopping for desired goods and services of any online third parties, such as merchants, manufacturers, vendors, etc. When a purchase decision is made, the user invokes or otherwise activates the cash account system and accesses the purchase page of the merchant. The cash account system provides the necessary charge account information to the user or otherwise on behalf of the user, which may be conditioned on the balance in the cash account. If sufficient funds are available, the cash account system consummates the sale to the user and deducts the purchase price, along with any other fees, from the balance of the user's cash account. If the funds are insufficient, the cash account system simply rejects the purchase transaction. Many other capabilities were disclosed and all such information and functionality may be incorporated in systems described herein, which are extensions of the prior disclosure.

The cash account system operates to enable online purchase transactions or the like and facilitates issuing valid charge numbers via a computer or telephonic network for subsequent purchases conducted via any type of electronic communications network as previously described. The charge information utilized by the cash account system includes a plurality of charge numbers issued by an issuing bank or financial institution. The issuing bank is a member of the Visa or MasterCard (MC) association of banks or the like, so that the charge numbers may be of the same format as standard, universally-accepted credit card numbers, such as Visa, MasterCard, American Express, Discover, etc. In this manner, the charge numbers may be utilized in existing charge settlement networks, such as the EFT network, the ACH network, etc. The cash account system further includes a processor that operates as a certified financial data processor for the charge numbers on behalf of the issuing bank. In this manner, during validation of any issuing system (IS) charge numbers via the charge settlement network, the transaction information is routed to the cash account system for verification and validation.

The IS charge numbers are further divided into card numbers and purchase numbers. Each card number is encoded onto a corresponding cash card, such as on the magnetic strip typically provided on “charge” cards, such as credit cards, debit cards, bank cards, etc. Each cash card may be configured in a similar manner as any typical charge card. The cash cards are then provided to brick and mortar merchants or distributors for sale to the public. A distributor is a merchant or vendor that distributes cash cards, although the term “distributor” also denotes a distributor of goods and/or related services. The cash cards may be utilized in a similar manner as cash cards previously described. In particular, each cash card includes a printed serial number for activation of an online cash account with the cash account system. Each cash card is first validated, however, by the distributor via the charge settlement network. For example, at the point of sale (POS) to the user, the cash card is swiped by a clerk into a card reader for validation. The information on the magnetic strip, including the card number, is forwarded via the charge settlement network to the cash account system as processor of the card number, which validates the cash card and the corresponding card number. Upon subsequent activation as described further below, the cash card with the card number may be used in a similar manner as a debit card. In one embodiment, the card number is not valid for any other transaction by itself, but is only valid in conjunction with a personal identification number (PIN), as described further below.

The purchaser of the validated cash card initiates a cash account online with the cash account system via a computer communications network or the like by entering the serial number printed on the card. The purchaser also provides a user ID and password to access the cash account for online purchases or other transactions, such as account transfers and the like. The user may provide other information, such as a PIN to be used in conjunction with the card number of the activated cash card, and a telephone number or the like for telephonic access and fund transfers. The cash account system associates the card number and the brick and mortar distributor from which the card was purchased with the cash account. The card and corresponding card number are then considered activated and may be used for offline purchase and cash transactions. The distributor is associated with locality information, such as any predetermined geographic area. A geographic area may be that particular store or distribution venue, a county, a city, a region, a state, a country, etc. The locality information may be static, such as a single distributor merchant store, or a group of distributors located within the geographic area, or may be dynamically determined, such as including certain distributors and merchants within a predetermined area or within a certain distance of the distributor that sold the cash card. In this manner, the cash account is associated with particular locality information based on where the card was purchased. The purchaser of the cash card, however, may remain anonymous since little or no personal information is collected by the distribution or the cash account system. It should be noted that even in the event where additional finds are added to the account by means of a bank transaction, all personal information would be stored separately and under a different encryption key. As an additional safeguard against potential security breaches of the database, the system may opt to discard, or not record the personal information of the user recharging the account.

Once the cash account is created or otherwise updated, the card number of the cash card is associated with the cash account. The cash card may be discarded in a similar manner as the cash cards previously described. In particular, the serial number is no longer valid and may not be used by another. Also, in one embodiment, the card number is not valid by itself and cannot be used apart from the card and the cash account PIN. Nonetheless, the cash card is activated may be utilized to purchase goods and services and to access cash via a standard automated teller machine (ATM) in a similar manner as a debit or bank card as long as the cash card is utilized in conjunction with the PIN. For example, the user may use the cash card at an ATM to receive cash from the cash account by inserting the card and entering the PIN in a similar manner as a bank or debit card. Also, the user may use the cash card with the PIN at any merchant to purchase goods or services in a similar manner as a bank or debit card. In either case, the card information is routed to the cash account system as processor of the card number, where the cash account system verifies the card number contained in the magnetic stripe and PIN. If valid and activated, the cash account system determines if the cash balance of the account is sufficient to cover the withdrawal or purchase amount in a similar manner as typical credit purchases. The account balance is adjusted and the transaction is approved if the card is active and the funds are sufficient. Otherwise, the transaction is simply denied.

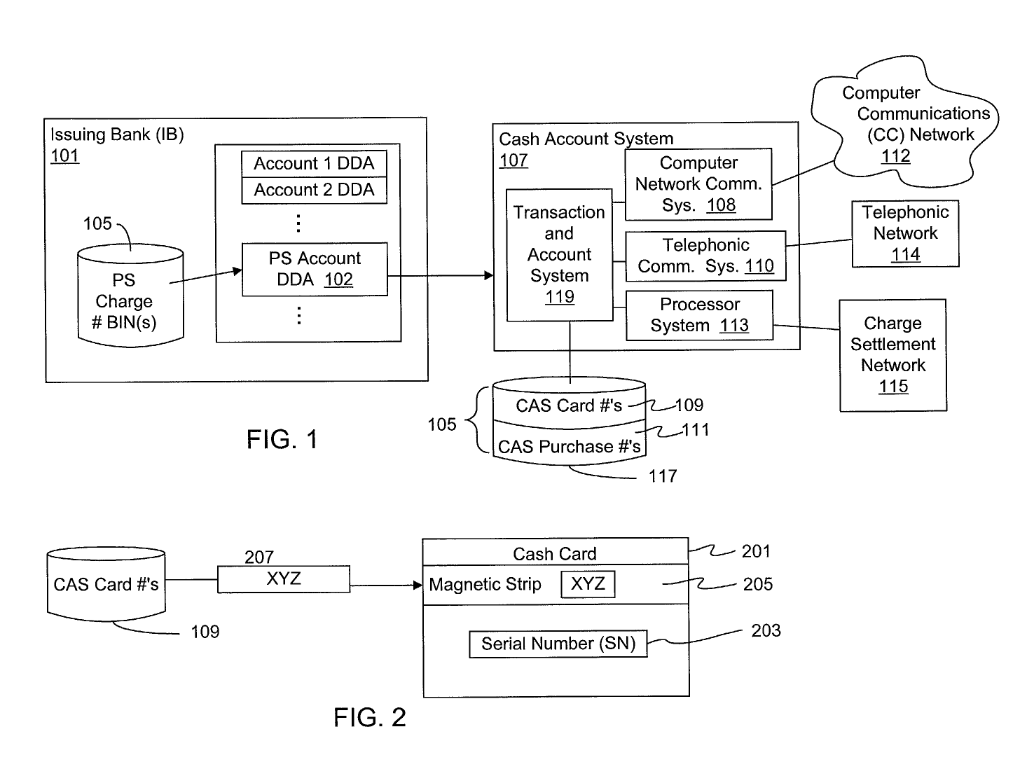

FIG. 1 is a block diagram illustrating charge number distribution from an issuing or sponsoring bank (IB) 101 and corresponding application. The issuing bank 101 is a bank or financial institution that is a member of an association of banks that sponsor certain credit or debit cards provided or licensed by Visa, MasterCard, American Express, Discover, etc. The issuing bank 101 typically distributes credit cards or the like to identified individuals or organizations that meet certain credit requirements. The issuing bank 101 establishes an account data base 103 including a plurality of separate direct deposit accounts (DDA), each for a separate individual or organization. As shown, the account data base 103 of the issuing bank 101 includes a multiple number of DDA accounts, including Account 1 DDA, Account 2 DDA, etc.

The account database 103 of the issuing bank 101 includes a cash account system (CAS) account DDA 102 that is associated with an online cash account system 107. The issuing bank (IB) 101 reserves a set or bin of CAS charge numbers 105 for the CAS account 102 for use by the cash account system 107 as customer. It is noted that the issuing bank 101 may actually issue the CAS charge numbers 105 to an entity associated with the cash account system 107, where the entity is a person or business entity or the like. The cash account system 107 further divides the CAS charge numbers 105 into two separate application categories including card numbers 109 and purchase numbers 111. As further described below, the card numbers 109 are provided or otherwise encoded upon plastic cash cards or the like and the purchase numbers 111 are each utilized for online purchase transactions or the like. It is noted that the purchase numbers 111 may also be loaded onto personal digital assistant (PDA) devices or smart cards or the like for “disconnected use” as further described below.

The CAS charge numbers 105 may be in any acceptable format. In one embodiment, the CAS charge numbers 105 are in the universally-accepted credit or debit number format comprising 16 numeric digits, such as is standard with “universally-accepted” Visa or MasterCard or American Express numbers as known to those of ordinary skill in the art. For example, the first four digits indicate a sponsoring or issuing bank and the next two digits indicate a bin of numbers. Several bins have been previously utilized to denote ATM, debit, credit, business credit, business debit, etc. It is noted, however, that the CAS charge numbers 105 may comprise any format now known or subsequently adopted as an appropriate and accepted format among distributors, merchants, manufacturers, etc., and thus may comprise more or less than 16 digits, and that may adopt alphanumeric numbering or the like. In general, any such numbers are considered “valid” or “authorized” charge numbers for use in conducting or otherwise consummating transactions, including various financial transactions, as described herein.

The cash account system 107 includes a computer network communication system 108 that enables the cash account system 107 to communicate with a computer communications network (CC) network 112 for enabling online purchase transactions. The computer communications network 112 may include or otherwise incorporate any type of local area network (LAN) or wide area network (WAN) as known to those skilled in the art. The computer communications network 112 may incorporate all or a substantive portion of any public/private global network online system (such as the “Internet”) and any intranets or extranets as desired. The cash account system 107 further includes telephonic communication system 110 for enabling communications with a telephonic network 114. As described previously, the electronic communications network encompasses the computer communications network 112 and the telephonic network 114. The cash account system 107 further includes a processor system 113 that enables interface and communication with a charge settlement network 115, such as the electronic EFT network and/or the ACH network or the like. The charge settlement network 115 enables any transfer of funds initiated through an electronic terminal, telephone, computer or magnetic tape, and may further include the EFT network, the ACH network, Fedwire transfers and transfers made at ATMs and point-of-sale (POS) terminals. The cash account system 107 is a certified financial data processor of the CAS charge numbers 105 and the processor system 113 is configured to handle processor functions via the charge settlement network 115. In this manner, the cash account system 107 is configured to interface the charge settlement network 115 and to operate as processor of the CAS charge numbers 105, including the card numbers 109 and the purchase numbers 111.

It is noted that the charge settlement network 115 incorporates, comprises or is otherwise part of the same charge settlement network that is used by online and/or brick and mortar merchants or the like to authorize, clear, settle, etc. transactions being conducted in association with valid charge numbers, such as standard debit or credit numbers provided on charge cards. For example, brick and mortar merchants typically include a validation unit or card reader or the like as part of the charge settlement network 115 for reading encoded charge numbers on magnetic strips on charge cards or the like. The charge card is swiped in the card reader (or the charge number printed thereon is typed onto a keypad) during a purchase transaction or the like, where the card reader reads and forwards the retrieved charge number via the charge settlement network 115 to an authorized or certified processor for the charge number to clear and/or settle the transaction.

The cash account system 107 further includes a transaction and account system 119 coupled to the computer network communication system 108, the telephonic communication system 110 and the processor system 113. The transaction and account system 119 shown generally incorporates the functions described in previous disclosures for the proxy system, including user interface(s), account activation system(s), account management system(s), transaction system(s), etc. As further described below, the transaction and account system 119 generally enables access to and management of one or more cash accounts, and also handles and enables online transactions via the computer communications network 112. The CAS charge numbers 105 are stored on a storage device 117 coupled to the transaction and account system 119. The storage device 117 represents any type of storage or memory device or system, such as tape or disk drives or the like configured with magnetic or optical media as known to those of ordinary skill in the art. The storage device 117 may be a single device or a plurality or bank of devices or computers or disk drives or the like, such as may be accessed via one or more server computers.

FIG. 2 is a block diagram illustrating an exemplary cash card 201 provided with a selected card number “XYZ” 207. One or more of the card numbers 109 are provided on a purchase media sold to the public. The purchase media may comprise a cash card 201 that may be configured similar to a standard debit or credit card having the same size and shape or configured according to any other similar wallet-sized card. The cash card 201 includes a surface for printing any type of information, such as a serial number (SN) 203. The serial number 203 is utilized to establish an online cash account with the cash account system 107 for enabling transactions including online purchases. In the embodiment shown, the cash card 201 further includes a magnetic strip 205 for encoding any type of information associated with the cash card 201 or the cash account system 107 such as a partial serial number, card advertising sponsor information, card bank sponsor information, lot number, monetary value, etc. As shown, the card number XYZ 207 from the card numbers 109 is encoded on the magnetic strip 205 of the cash card 201. In this manner, the cash card 201 is implemented to be utilized within the charge settlement network 115 in a similar manner as a bank or debit or ATM cash card utilized at any ATM. The card number XYZ 207 may additionally be printed on or otherwise inscribed into the cash card 201 as is typical for standard charge cards for easy reading and access. For improved security reasons, however, the card number XYZ 207 is not printed or inscribed but remains encoded only. Encoding only embodiments provides improved security in that the card number is not readily retrievable or accessible. As described further below, it may be desired to only authorize transactions with the card number in conjunction with a corresponding personal identification number (PIN) in a similar manner as a debit card.

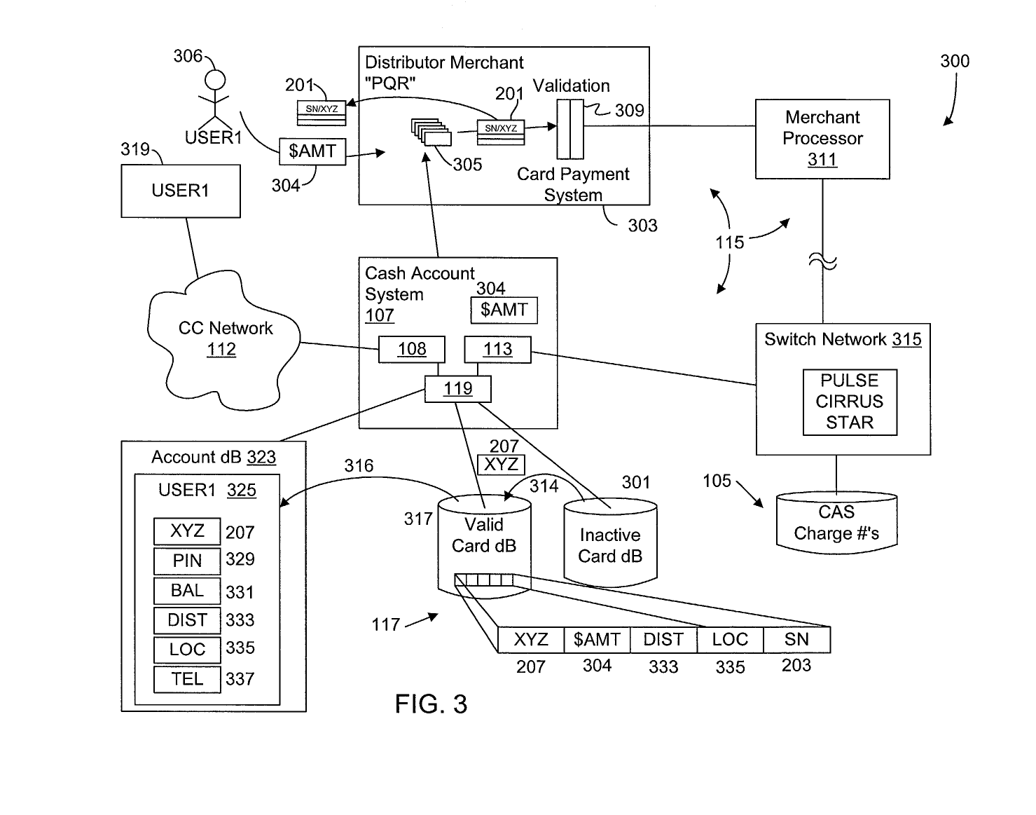

FIG. 3 is a block diagram of a charge number issuing and processing system 300 illustrating usage of cash cards similar to the cash card 201 for performing transactions including financial and purchase transactions as described herein. The card numbers 109 are initially provided or otherwise stored within an inactive card database (dB) 301 associated with or coupled to the transaction and account system 119 of the cash account system 107. A plurality of cash cards 305, each similar to the cash card 201, are provided to a distributor merchant 303, such as represented by a particular distributor merchant “PQR”. A distributor merchant 303 is simply a merchant that distributes cash cards, such as the cash cards 305. The inactive card database 301 may optionally include information associated with the distributor merchant PQR and/or additional information about the local area or “locality” of the distributor merchant PQR, as further described below. The inactive card database 301 may also include a unique serial number for each of the cash cards 305, such as the serial number 203.

A user 306, referred to as “USER1”, purchases one of the cards 305 in exchange for cash 304 of a certain cash amount ($AMT) 304 provided to the distributor merchant PQR. The distributor merchant PQR selects a cash card from the stack 305, such as the cash card 201, and swipes the selected cash card 201 in a card swipe machine or card reader or the like of a card payment system 309 for purposes of initiating a point of sale (POS) transaction associated with the selected cash card 201 for validation. The card payment system 309 is coupled to the charge settlement network 115 as previously described in any standard fashion, such as via a telephonic network or the like. It is noted that most merchants include such a card reader or the like to clear transactions normally associated with debit or credit cards using the charge settlement network 115 to clear transactions. Since the card number on the selected cash card is a valid charge number in the format of standard charge numbers, there is no further integration required with any particular merchants. The same card readers employed for standard charge cards are used to conduct the POS transaction to validate and enable subsequent activation of the card number on the selected cash card.

When the cash card 201 is swiped in the card payment system 309, the information on the magnetic strip 205 is provided via the charge settlement network 115 to a merchant processor 311 or the like. The merchant processor 311 “settles” the POS transaction through the charge settlement network 115 as part of the charge settlement network in a normal or standard manner. In one embodiment, a merchant discount associated with the particular merchant initiating the POS transaction, such as the distributor merchant PQR, is deducted from the transaction amount. During the clearing process, the merchant processor 311 forwards the transaction information to the particular association (not shown) of which the issuing bank 101 belongs, such as Visa or MasterCard or American Express or Discover, etc. The association forwards the transaction information to a switch network 315 within the charge settlement network 115. The switch network 315 has previously been provided with the CAS charge numbers 105 issued to the cash account system 107. In one embodiment, the switch network 315 stores the CAS charge numbers 105 locally. The switch network 315 forwards or otherwise routes the information to the cash account system 107 as certified processor since the card number XYZ 207 is part of the CAS charge numbers 105 to be processed by the cash account system 107. The processor system 113 retrieves the information from the distributor merchant 303 and determines if the received number is within the inactive card database 301. If the received number is recognized as a valid card number within the inactive card database 301, such as the card number XYZ 207, then the card number XYZ 207 is moved from the inactive card database 301 into a valid card database 317 as indicated by transfer arrow 314. In this manner, the card number XYZ 207 has effectively become validated. It is noted that the databases 301, 317 are incorporated on the storage device 117 in the embodiment shown, although the databases may be stored in any other manner in any desired format.

In one embodiment, the distributor merchant PQR provides the purchase amount 304 provided from USER1 306 during validation in a similar manner as a purchase amount provided for a credit card purchase transaction. Thus, the purchase amount 304 is transferred to the cash account system 107 via the charge settlement network 115 during validation. The purchase amount 304 is stored and associated with the card number XYZ 207 for subsequent purposes of activation of an associated account and the cash card 201. In an alternative embodiment, the cash card 201 is associated with a predetermined amount, such as $20, $50, $100, or the like, and the distributor merchant PQR has the responsibility to collect the appropriate amount of funds for the face value of the cash card 201. In the latter embodiment, the purchase amount 304 is initially stored in the inactive card database 301 along with the card number XYZ 207. The purchase amount 304 may be incorporated within the serial number 203 of the cash card 201 and identified at the cash account system 107.

The valid card database 317 includes other information that is associated and stored with the particular validated card number XYZ 207. The associated information may be retrieved from the inactive card database 301 if initially stored there, or is retrieved via the charge settlement network 115 from the magnetic strip 205 and any other transaction information forwarded via the charge settlement network 115. In particular, the valid card database 317 stores the validated card number XYZ 207 along with the cash or purchase amount 304 and a distributor or promoter identifier 333 identifying the particular distributor merchant PQR associated with the cash card 201. The valid card database 317 may further store a portion of or the entire serial number 203 associated with the particular card number XYZ 207. For example, the card numbers and corresponding serial numbers may initially be stored in the inactive card database 301 after the cash cards are created. The cash account system 107 may further store locality information (LOC) 335 associated with the particular distributor merchant PQR. The locality information 335 identifies a particular local geographic area associated with a distributor merchant 303, such as PQR, and may include information about the particular distributor merchant PQR itself. The locality information 335 may be determined in any one of several manners. In one embodiment, the locality information 335 identifies the distributor merchant 303 itself, and/or its location, such as a county, city, region, state, etc. The locality information 335 may alternatively indicate a plurality of other distributors within the same geographic area as the distributor merchant 303. In this manner, the cash account system 107 may preliminarily associate a distributor identifier and locality information with a corresponding card number and the cash card when a stack of cash cards is initially provided to a distributor merchant 303, or at a subsequent time when a cash card is actually purchased by a user via a distributor merchant 303 and the charge settlement network 115.

USER1 306 subsequently accesses the computer communications network 112 via a node or computer, such as a USER1 computer 319, to create a cash account “USER1” associated with the validated cash card 201 and to set a cash balance amount (BAL) 331 according to the purchase amount 304. Alternatively, the purchase amount 304 associated with the cash card 201 is added to the cash balance 331 of an existing USER1 account. USER1 306 using the USER1 computer 319 interfaces the cash account system 107 via the computer communications network 112 and provides the serial number 203 identifying purchase of the cash card 201. In one embodiment, for example, the serial number 203 is associated with the validated card number XYZ 207 since provided on the same cash card 201. USER1 306 indicates the desire to either create a new account in an accounts database 323 of the cash account system 107 or to otherwise update an existing cash account. In either event, a USER1 account 325 is created or otherwise accessed and updated. The accounts database 323 may be stored on the storage device 117 in a similar manner as previously described.

The USER1 account 325 is created or otherwise updated by the cash account system 107 to include or otherwise be associated with the card number XYZ 207 and any other information to enable online transactions by USER1 306 via the cash account system 107. For example, any information stored in the valid card database 317 corresponding to the card number XYZ 207 is transferred to or otherwise associated with the USER1 account 325 as indicated by arrow 316. In particular, the balance 331 of the USER1 account 325 becomes the purchase amount 304 or the purchase amount 304 is added to any existing prior balance. The USER1 account 325 is updated with the distributor identifier 333 and the locality information 335. The serial number 203 may optionally be stored if desired. The distributor identifier 333 identifies the distributor merchant 303 such as PQR at which the cash card 201 was purchased and the locality information associated with the distributor merchant 303. The USER1 account 325 may further include a PIN 329 that may be utilized in conjunction with the cash card 201 for off-line purchases and retrieval of cash. The USER1 account 325 may further include or otherwise be updated with a telephone number identifier (TEL) 337. The telephone number identifier 337 is a seven digit access number or the like that may be used in conjunction with the telephonic network 114 to identify the USER1 account 325 for fund transfers or deposits or the like. The telephonic network 114 may be voice activated if desired, so that the telephone number identifier 337 may be entered manually via a telephone keypad or the like or may be entered verbally. Once the validated card number XYZ 207 is associated with a particular cash account, such as the USER1 account 325, the cash card 201 and the corresponding card number XYZ 207 are considered activated.

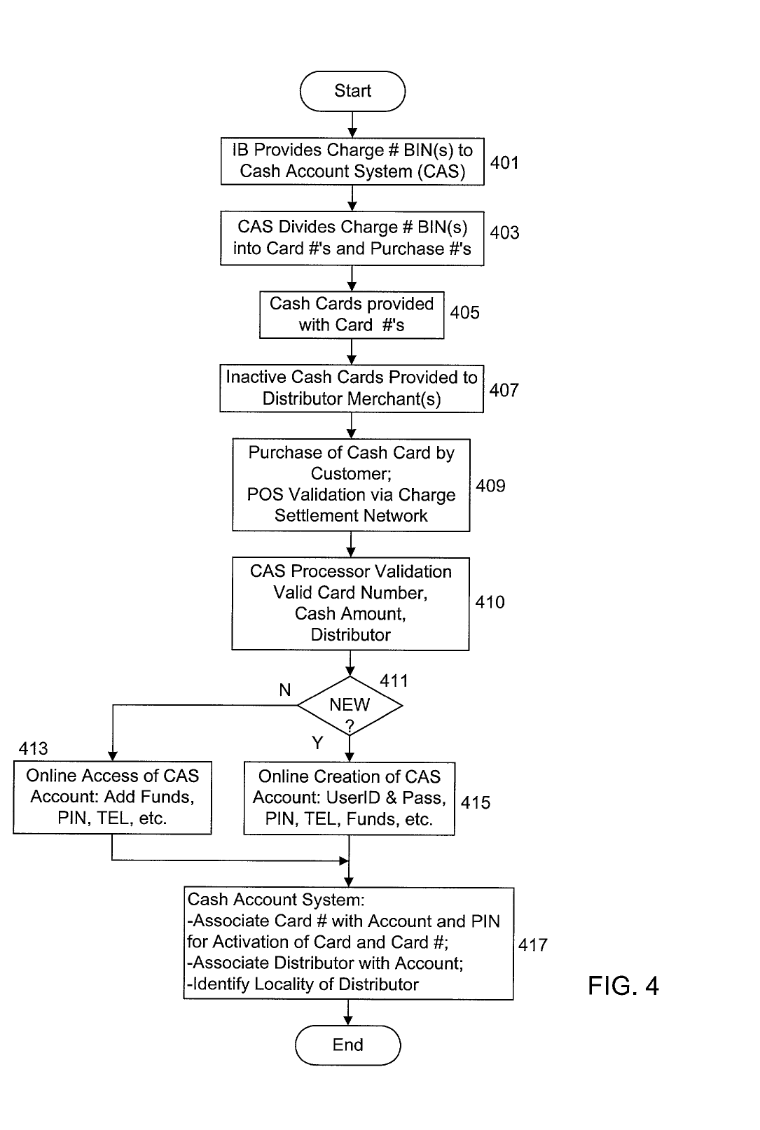

FIG. 4 is a flow chart diagram illustrating activation and operation of the charge number issuing and processing system 300. At first block 401 the issuing bank 101 provides the CAS charge numbers 105 to the cash account system 107. At next block 403, the cash account system 107 divides the charge number bin into card numbers 109 and purchase numbers 111. At next block 405, one or more cash cards are provided with corresponding card numbers and provided to distributor merchants 303, such as the distributor merchant PQR. The card numbers may be encoded if desired, such as onto a magnetic strip or the like. At next block 409, a user, such as USER1 306, purchases a cash card, such as the cash card 201, at a distributor merchant 303, and the purchased cash card is POS validated by submitting the number via the charge settlement network 115. At next block 410, the cash account system 107 operates as processor during the POS transaction to validate the card number XYZ 207 of the cash card 201 via the charge settlement network 115 and to determine the associated cash amount, if desired, along with an associated distributor identifier 333 and locality information 335. The validated card number is stored along with the associated cash amount and other associated information, such as in the valid card database 317.

At next block 411, the purchaser of the cash card accesses the cash account system 107 via the computer communications network 112 and either establishes or activates a new cash account or accesses and adds finds to an existing cash account. For an existing cash account, operation proceeds to next block 413 in which the user accesses the existing account, provides the serial number 203, and adds the purchase amount 304 to the existing account. Also, the PIN 329 may be assigned and associated with the validated card number. Alternatively, if a new account is to be created, operation proceeds to next block 415 in which the user performs online initiation and creation of a new cash account via the cash account system 107. In particular, the serial number 203 is provided to associate with the cash card 201 and the user provides a user identifier and password for subsequent access of the account. The user identifier and password is collectively referred to as identification information to identify the user for subsequent access of the cash account. Also, a PIN is assigned to the card number 327, if desired, and the purchase amount 304 is added to the account. At next block 417, the cash account system 107 associates the information, including card number, purchase amount, PIN, distributor identifier, locality information, telephone number identifier, etc. with the existing account or the new account and operation is completed. Once the card number 327 is associated with a cash account, the card number 327 and corresponding cash card are considered activated.

It is noted that the USER1 account 325 and USER1 306 are both associated with the name “USER1” as shown for purposes of illustration and clarity. It is appreciated that the actual user or customer may remain anonymous by providing any arbitrary user ID and password that need not convey personal information the particular user. Thus, the actual name, address, telephone number, etc. and any other personal information remains confidential and need not be conveyed for the charge number issuing and processing system 300 to successfully operate. Users may remain anonymous if desired.

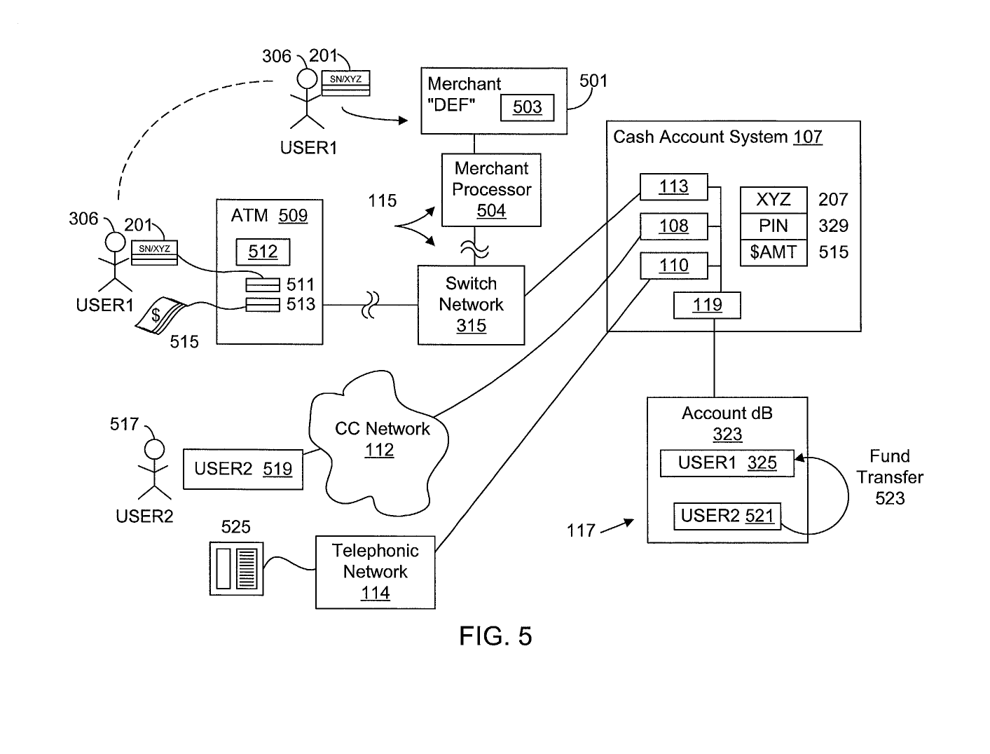

FIG. 5 is a block diagram illustrating use of cash cards as described herein in association with cash accounts through the cash account system 107. USER1 306 presents the cash card 201 to any merchant 501, such as a particular merchant “DEF”, that accepts debit cards as payment for goods or services. In exchange for goods and services, the merchant DEF receives the cash card 201 for payment via a card payment system 503, which is similar to the card payment system 309 and is configured to receive and forward a PIN. For example, the cash card 201 is swiped by the merchant 501 in a card reader or the like, and the PIN is entered on a keypad or the like. Thus, USER1 306 provides the PIN 329 in conjunction with use of the cash card 201 to the merchant 501, which then clears the transaction via the charge settlement network 115. The information on the magnetic strip 205, the purchase amount 304 and the PIN are conveyed to a merchant processor 504 associated with the merchant DEF, which performs clearing and settling functions in a similar manner as described for the merchant processor 311. The merchant processor 504 may also deduct any merchant discount on behalf of the merchant DEF. During the clearing process, the merchant processor 504 forwards the transaction information to the switch network 315 via the charge settlement network 115 as previously described. The card number XYZ 207 is determined by the switch network 315 to be associated with the cash account system 107 as processor, so that the transaction information is conveyed to the cash account system 107 as previously described.

The cash account system 107 receives the transaction information via the charge settlement network 115 and performs validation, verification and/or authorization transactions as necessary for processing. For example, the transaction and account system 119 receives a card number, a PIN and a purchase amount. The transaction and account system 119 verifies whether the received card number is the same as any activated card number in the accounts database 323. For the cash card 201, for example, transaction and account system 119 accesses the USER1 account 325 from the accounts database 323. The transaction and account system 119 determines if enough funds are available in the USER1 account 325 for the purchase transaction, such as comparing the purchase amount of the transaction with the cash balance 331. If the received card number is activated and if the purchase amount 304 does not exceed the cash balance 331 of the USER1 account 325, then the purchase transaction is authorized and accepted by the cash account system 107. If approved, the processor system 113 returns authorization information, such as authorization codes or the like, to the merchant DEF via the charge settlement network 115. The merchant DEF respondingly accepts payment via the cash card 201. Otherwise, the cash account system 107 denies the transaction and the processor system 113 returns denial information, such as denial codes or the like, to the merchant DEF via the charge settlement network 115. If a PIN is required for authorization, then the transaction and account system 119 further compares the received PIN with the PIN 329 and authorizes the transaction only if the respective PINs are the same.

USER1 306 may further use the cash card at a standard ATM 509 in association with the PIN 329, where the ATM 509 initiates and conducts a cash transaction on behalf of USER1 306. In particular, the cash card 201 is inserted into a card receiver slot 511 and the PIN 329 is entered into a keyboard 512 or the like of the ATM 509. USER1 306 also punches in a desired cash amount 515 via the keyboard 512. The PIN 329, the desired cash amount 515 and the information on the magnetic strip 205 including the card number XYZ 207 is forwarded by the ATM 509 and the switch network 315 of the charge settlement network 115 to the cash account system 107 as processor. The transaction and account system 119 of the cash account system 107 verifies the card number XYZ and the PIN 329 and verifies or otherwise compares the information with the USER1 account 325. The cash amount 515 is compared with the account balance 331 of the USER1 account 325. If the received card number is valid and is the same as an activated card number, such as the card number XYZ 207, if the received PIN is the same as the authorized PIN, such as the PIN 329, and if the cash amount 515 does not exceed the current balance 331 in the USER1 account 325, then the cash account system 107 accepts the transaction. Otherwise, the transaction is denied. The acceptance or denial information is returned to the ATM 509 by the processor system 113. If the transaction is accepted, the ATM 509 provides the cash amount 515 to USER1 306 via a cash slot 513. There may be other operating parameters that may be considered, such as a cash transaction limit on the amount of cash withdrawal at the ATM 509. Such limits, if effective, are also considered by the ATM 509 and/or the cash account system 107 before accepting the transaction. In this manner, the cash card 201 is used much the same way as a cash debit or credit card in a standard ATM.

Another user of the cash account system 107, referred to as “USER2” 517, may access the cash account system 107 via a USER2 computer 519 or the like coupled to the computer communications network 112. A USER2 account 521 is either created or accessed within the account database 323 of the cash account system 107 to enable USER2 517 to perform online transactions via the computer communications network 112. Further, USER2 517 may transfer finds from the USER2 account 521 to the USER1 account 325 via the cash account system 107 as indicated by a fund transfer arrow 523. USER1 306 may then access the transferred funds from the USER1 account 325 utilizing the cash card 201 at the ATM 509 or via any merchant 501, or via online transactions. USER2 517 may also perform the fund transfer 523 via a standard telephone 525 coupled to the telephonic network 114. In particular, USER2 517 may dial a predetermined number, such as a toll or toll-free number, via the telephonic network 114. The telephonic communication system 110 of the cash account system 107 enables access to the accounts database 323 via the transaction and account system 119 for authorized users. The telephonic communication system 110 may be voice-activated enabled if desired to allow verbal entry of the telephone number identifier 337. In this manner, USER2 517 may utilize the telephone number identifier 337 of the USER1 account 325 to transfer funds from the USER2 account 521 to the USER1 account 325. Given that the fund transfer occurs within the accounts database 323, the transfer of funds can be subject to database manager rules. In one embodiment, a restriction can be added to the funds transferred by USER2 517, yet allowing USER1 306 to verify that the transfer cannot be undone, and that the funds if freed from the restriction by USER2 517, or the cash account system 107, would be made available for purchase or withdrawal.

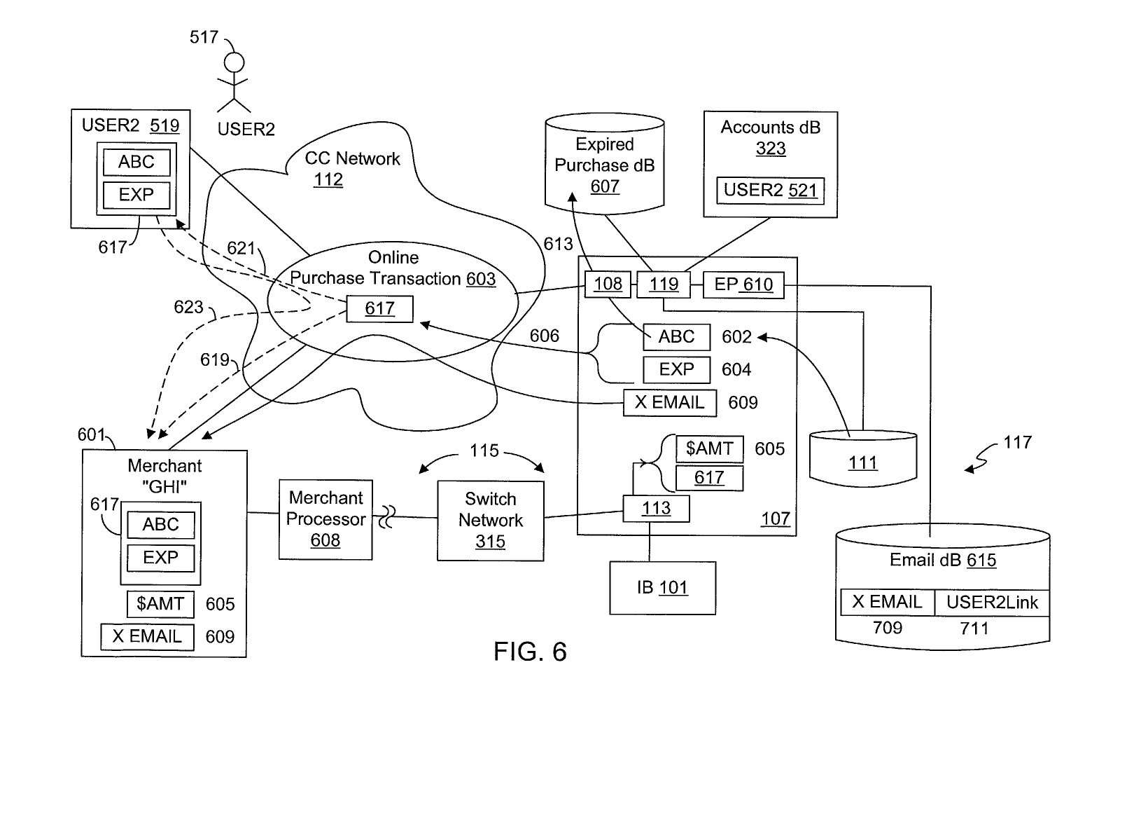

FIG. 6 is a block diagram illustrating an online purchase transaction by a user or customer using the cash account system 107 via the computer communications network 112. USER2 517 accesses the computer communications network 112 via the USER2 computer 519 and shops for goods and services online via a plurality of merchants 601. USER2 517 identifies a good or service to be purchased from a merchant 601, such as a particular merchant “GHI”, and decides to purchase the goods or services. The cash account system 107 is invoked to conduct an online purchase transaction 603 by USER2 517. In particular, USER2 517 via the USER2 computer 519 interacts with a purchase page from the merchant GHI indicating a desire to purchase. The transaction and account system 119 detects the request for purchase via the computer network communication system 108, selects a valid purchase number and provides the selected purchase number to enable consummation of the online purchase transaction 603. For example, the transaction and account system 119 retrieves a selected valid purchase number, such as “ABC” 602, from the purchase number database 111 and provides the selected valid purchase number ABC 602 via the computer communications network 112. It is noted that the online purchase transaction 603 is only one example of a request for a valid charge number. USER2 517 or any other cash account system 107 user may request a valid charge number via the computer communications network 112 in and other manner, such as directly requesting via the cash account system 107.

If necessary or if otherwise desired, the transaction and account system 119 may also generate an expiration date (EXP) 604. Although the expiration date 604 could be determined by the issuing bank 101 when provided to the cash account system 107, the expiration date 604 may alternatively be determined by the cash account system 107. The cash account system 107 may pre-determine the expiration date 604, or may generate the expiration data 604 dynamically during the online purchase transaction 603. In one embodiment, the expiration date 604 is the same date of the online purchase transaction 603 or otherwise has a short expiration period. In another embodiment, the expiration date 604 is randomly generated within parameters to ensure acceptance by online merchants 601, such as the merchant GHI. For example, the expiration date 604 retains a valid format “MMYY”, where MM represents two digits for any month 01-12 and YY represents two digits for any valid year 00-99. Of course, Y2K compliant formats are contemplated. Also, the valid expiration date 604 is the same date or is a future date to prevent rejection by online merchants 601. The valid charge number ABC 602 and the valid expiration date 604 are collectively shown as valid charge information 617.

As indicated by arrow 606, the transaction and account system 119 provides the valid charge information 617 via the computer communications network 112 in response to the online purchase transaction 603. In one embodiment as indicated by dashed arrow 619, the valid charge information 617 is provided to the merchant GHI to consummate the online purchase transaction 603, such as via a purchase page provided by the merchant GHI. For example, the purchase number ABC 602 and the expiration date 604 are inserted into the merchant purchase page. In an alternative embodiment, the valid charge information 617 is provided to USER2 519 as indicated by dashed arrow 621. In either case, the cash account system 107 associates the valid charge number ABC 602 or the valid charge information 617 with USER2 519 for transaction authorization. Such association may be performed in a similar manner as described previously for the selected card number XYZ 207 associated with the USER1 account 325, such as storing the valid charge number ABC 602 or the valid charge information 617 in the USER2 account 521 associated with USER2 517. Of course, any other manner of association may be employed.

USER2 517 has an option of providing the valid charge information 617 to the merchant GHI as indicated by another dashed arrow 623 to consummate the online purchase transaction 603. For example, USER2 519 may cut and paste the valid charge information 617 from the cash account system 107 into the merchant purchase page or may select an automatic population option offered by the cash account system 107 that automatically fills the valid charge information 617 into the purchase page upon indication by USER2 519. In an alternative embodiment, USER2 519 has an option of keeping the valid charge information 617 for a subsequent transaction and terminating the online purchase transaction 603. The valid charge information 617 remains valid for any subsequent purchase transaction as long as not exceeding the provided expiration date 604.

If USER2 519 utilizes the valid charge information 617 to consummate the online purchase transaction 603, then the merchant GHI utilizes the charge settlement network 115 to forward the charge information to clear the purchase transaction and determine validity of the purchase number ABC 602 in a similar manner as previously described, except that the transaction is cleared without the use of a cash card or card reader. The verification may occur immediately or subsequently via the charge settlement network 115 in a similar manner as previously described. In particular, the merchant GHI submits the valid charge information 617 including the purchase number ABC 602 and expiration date 604 and a transaction amount ($AMT) 605 to the charge settlement network 115. The valid charge information 617 and transaction amount 605 is received by a merchant processor 608 associated with the merchant GHI. The merchant processor 608 settles the purchase transaction and deducts a merchant discount, if any, in a similar manner as previously described. The merchant processor 608 forwards the purchase transaction information to the switch network 315, which routes the transaction information to the cash account system 107 as processor.

The cash account system 107 is pre-certified as processor for any of the CAS charge numbers 105, including the purchase numbers 111. The processor system 113 and the transaction and account system 119 receive and verify the charge number received from the charge settlement network 115 as being the selected purchase number ABC 602. If the received and selected charge numbers are not the same, then the transaction and account system 119 aborts the transaction and the processor system 113 returns denied information. If the charge numbers match, the processor system 113 compares a received expiration date with the associated expiration date 604 provided via the computer communications network 112 with the valid transaction number ABC 602. If the expiration dates do not match, then the processor system 113 returns denial information. It is noted that the expiration date comparison may simply be a match determination rather than an actual expiration determination since the cash account system 107 is more concerned with matching than expiration. If the expiration dates match, the transaction and account system 119 accesses an associated cash account in the accounts database 323 and compares the received transaction amount 605 with the account balance. For example, for USER2 519 and the associated purchase number ABC 602, the transaction and account system 119 accesses the remaining cash balance in the USER2 account 521 in the accounts database 323. If the cash balance in the USER2 account 521 is insufficient for the transaction amount 605, then the processor system 113 returns denied information to reject the transaction. Otherwise, the transaction is approved and the processor system 113 returns authorization information to the merchant GHI, which completes the online purchase transaction 603.

In one embodiment, after the online purchase transaction 603 is completed, the cash account system 107 “expires” the purchase number ABC 602 by storing or otherwise transferring the purchase number ABC 602 into an expired purchase database 607 as indicated by arrow 613. Once expired in this manner, the charge number is no longer considered valid and may not be employed for subsequent purchase transactions. The cash account system 107 provides many valid purchase numbers, detects the provided valid charge numbers used to consummate corresponding purchase transactions, and then expires each one into the expired purchase database 607. The expired purchase database 607 may be stored on the storage device 117. The single use and immediate expiration of purchase numbers provides a significant level of security in that any purchase number utilized via the computer communications network 112 become invalid after completion of the online purchase. If one or more purchase numbers are stolen, either before or after online use, the cash account system 107 as processor detects and denies attempted subsequent purchase transactions. Any information collected during the attempted illicit purchase may be utilized to track down and capture the perpetrator.

The cash account system 107 processes a plurality of such online purchase transactions over a period of time. After a predetermined period of time, or after a certain number of transactions are completed, the cash account system 107 sends settled purchase transactions, including the online purchase transaction 603, to the sponsoring or issuing bank 101. Settled transactions may be sent, for example, via an ACH batch transfer or the like. The issuing bank 101 further settles the transactions with any entities of the charge settlement network 115 as necessary or desired. The issuing bank 101 may also processes ACH transfers or the like from merchants or distributors, such as the distributor merchants 303, and credit funds to the entity associated with the cash account system 107.

An email system including an email processor (EP) 610, coupled to the transaction and account system 119, and an email database 615, interfacing the email processor 610, may further be utilized to enable communication between USER2 517 and the merchant GHI from which goods or services were purchased. The email database 615 may be stored on the storage device 117. During the online purchase transaction 603, the merchant GHI may request an email address in order to subsequently contact USER2 517. The email processor 610 of the cash account system 107 manufactures a new email account associated with the email database 615, or otherwise accesses an existing email account, and provides an email address 609, denoted “X EMAIL”, to the merchant GHI. The email processor 610 further links the X EMAIL address 609 with the USER2 account 521 using a USER2 611 or the like within the email database 615. Any email from the merchant GHI using the X EMAIL address 609 is forwarded to the USER2 account 521 for viewing by USER2 517. In this manner, USER2 517 may access the USER2 account 521 and view the email sent from merchant GHI.

The X EMAIL address 609 is associated with the particular transaction by the merchant, but does not provide any identify or personal information of USER2 517. In one embodiment, the X EMAIL address 609 is only linked to the USER2 account 521 for receiving emails using the X EMAIL address 609. USER2 517 may reply to the merchant sending the email using the email address provided by the merchant. The email from USER2 517 is sent from the cash account system 107 on behalf of USER2 517 but otherwise does not convey any confidential information. In this manner, USER2 517 remains completely anonymous to the merchant GHI or any other merchant 601 and may further be anonymous with respect to the cash account system 107 if desired. USER2 517 may contact the merchant GHI directly to discus the contents of the email if desired. It is further noted that if the merchant GHI attempts to sell the X EMAIL address 609 to other vendors or merchants or advertisers, then USER2 517 may track the source of the potentially unauthorized email to the merchant GHI.

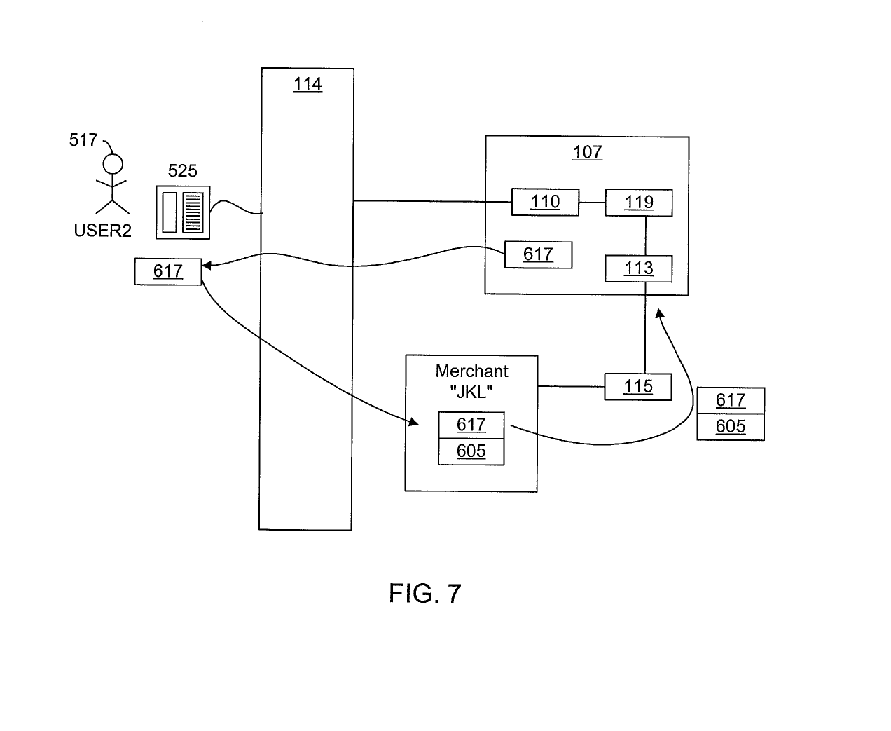

FIG. 7 is a block diagram illustrating a request by USER2 517 from the cash account system 107 via the telephonic network 114 to request a valid purchase number and to conduct a purchase transaction with the merchant GHI using the provided valid charge number via the telephonic network 114. As shown, USER2 517 utilizes the telephone 525 to access his USER2 account 521 via the telephonic network 114, the telephonic communication system 110 and the transaction and account system 119 of the cash account system 107. In this case, USER2 517 requests a charge number to conduct a subsequent purchase transaction. In a similar manner as described above in relation to the online purchase transaction 603, the valid charge information 617 is provided from the cash account system 107 to USER2 517 in response to the request, except in this case the information is provided via the telephonic communication system 110 and the telephonic network 114. After USER2 517 receives the valid charge information 617,

either by the telephonic network 114 or the computer communications network 112, USER2 517 may conduct a telephonic purchase transaction with any merchant 601, such as a merchant “JKL”, using the valid charge information 617 via the telephonic network 114, such as standard mail order purchases using the telephone 525. The merchant JKL clears the transaction via the charge settlement network 115 in a similar manner as previously described.

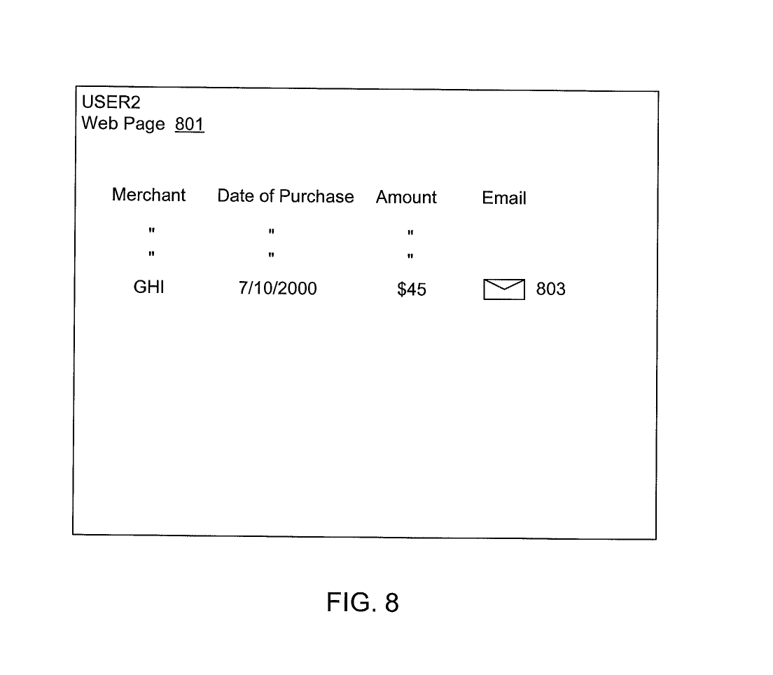

FIG. 8 is a screen shot of an exemplary web page 801 that may be displayed by the cash account system 107 to the USER2 computer 519 when USER2 517 is accessing the USER2 account 521. The web page 801 is utilized to provide information of transactions conducted by USER2 517 utilizing the USER2 account 521 or any other account established or controlled by USER2 517. For example, the web page 801 may list any merchants associated with a given transaction, the date of the purchase transaction and the corresponding purchase amount. Furthermore, an email icon 803 may be provided and displayed adjacent any particular transaction and thus associated with the corresponding merchant that sent the email. USER2 517 may open the email by clicking or accessing the icon 803. USER2 517 may reply to the sender using the return address supplied by the sender in normal email fashion. The email from USER2 517 is from the cash account system 107 with the X EMAIL address 609, which does not convey any confidential information. In this manner, USER2 517 may correspond with the merchant while remaining anonymous if desired. Of course, USER2 517 has the option of directly contacting the merchant to resolve any issues.

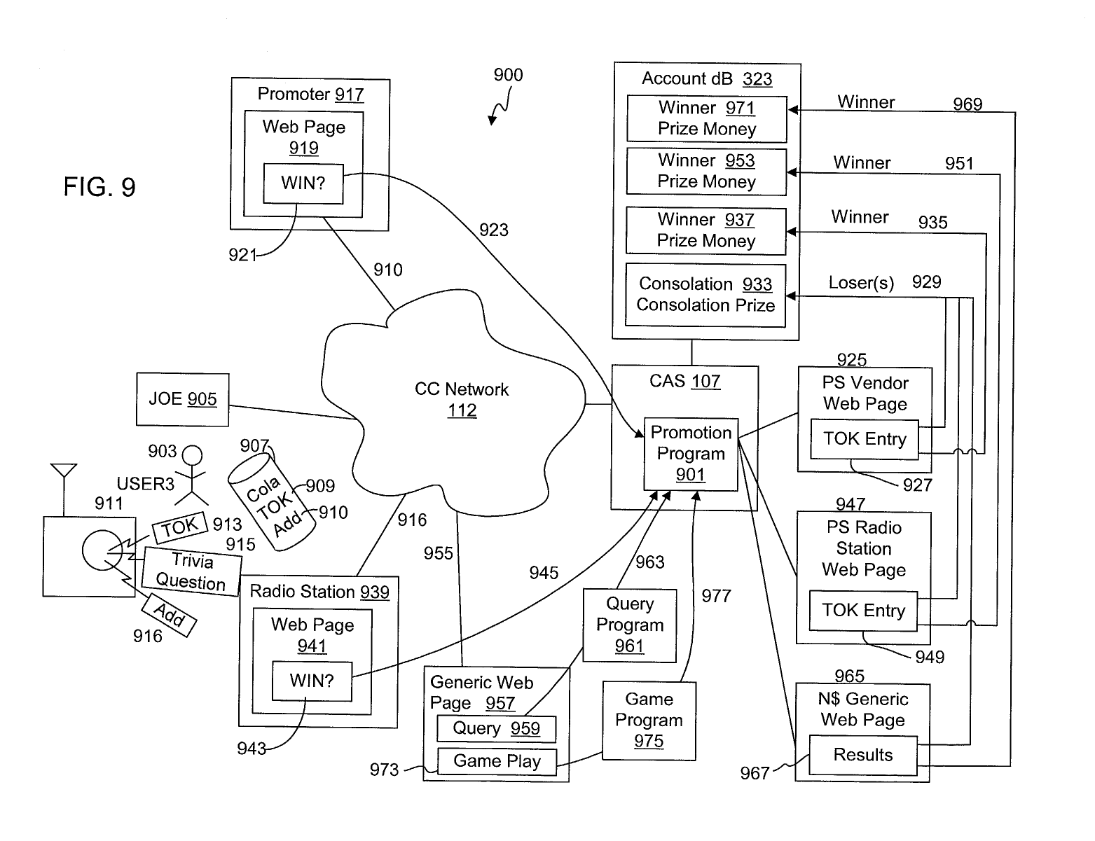

FIG. 9 is a block diagram of an online promotional system 900 utilizing the cash account system 107 with the account database 323. A promotional scheme is determined by a merchant, a manufacturer, a distributor, etc. collectively or individually referred to as the promoter 917, a radio station 939, a television station (not shown), a newspaper (not shown), a company (not shown) or any other entity. In one embodiment, the promoter 917 prints a token (TOK) 909, which is any alphanumeric digital value, such as a serial number including a manufacturer's serial number (MSN), or a codeword, or a barcode, or any type of symbol or the like directly on product packaging manufactured or distributed by the promoter 917, such as, for example, on a cola can 907. The promoter 917 may then publish additional information about the promotional scheme in any desired manner. The other information may include details and rules about the promotional scheme and a web address 910 or the like that is utilized by an individual to access a corresponding web page 919 associated with the promoter 917 and the promotional scheme. Some or all of the additional information may be printed directly on the product packaging sold to the public. Alternatively, the promoter 917 may utilize any available public media to publish the additional information, such as radio, television, newspapers, magazines, periodicals, the Internet, etc.

The TOK 909 may be determined specifically for purposes of the promotional scheme and printed on the product packaging. Alternatively, the TOK 909 may comprise an existing number generally utilized for any purpose, such as lot numbers, date information, packaging information, etc. In this manner, there is no need to retrofit packaging with supplemental information. In either case, a list of tokens or the like are provided to the cash account system 107 along with identification of one or more winning values. The web address 910 may be printed on the packaging or published via the media as previously described. A person with a winning token that accesses the web page 919 in accordance with the contest procedures wins prizes or prize money as further described below. The ability to utilize existing MSN's on existing packaging as the tokens enables substantial reduction of cost of conducting the promotional scheme. The other information, such as promotion details, rules, etc. may be published on the web page 919 accessible by anyone using the web address 910.

In a similar manner, the radio station 939 may broadcast information associated with its promotional scheme, such as a details and rules of the scheme, an alphanumeric token (TOK) 913 (such as a merchant's serial number, codeword or symbol or the like), or a trivia question 915 or the like, a web address 916 for accessing a web page 941 associated the radio station 939, etc. The TOK 913 of the radio station 939 may be utilized in a different manner as the TOK 909 since broadcast or announced to multiple people rather than an individual. For example, the first person to access the web page 941 with the published TOK 913 may be considered the winner. The trivia question 915 may be utilized in a similar manner, except that the entrant must answer the question correctly to win.

An entrant 903, referred to as “USER3”, purchases a product, such as cola can 907 and reads the TOK 909 from the packaging. The web address 910 may be printed on the cola can 907 or publicized in any manner as previously described. Alternatively, USER3 903 hears the promotional scheme information from a radio 911 or the like, including the TOK 913 or a trivia question 915 and the web address 916. USER3 903 accesses the corresponding web page via the computer communications network 112 and a USER3 computer 905. The web pages 919 or 914 include a corresponding interactive link 921 or 943, respectively, such as a graphic button or icon or the like, in order for USER3 903 to participate in the promotional scheme. Selection or activation of the link 921 or 943 causes a link transfer to the cash account system 107 such as via link 923 or 945, respectively. The links 923 and 945 further include identifier information so that the cash account system 107 associates the link 923 with the promoter 917 and the link 945 with the radio station 939.

The cash account system 107 includes a promotion program 901 that redirects USER3 903 to a corresponding web page 925 or 947 associated with the promoter 917 or the radio station 939, respectively. The web pages 925 and 947 include corresponding entry fields 927 and 949, respectively, for entering the TOK 909 or 913 retrieved from the product packaging or heard via the radio 911 or other public media. One or more of the TOKs may correspond to a winning value and corresponding prize money. If the TOK 909 or 913 is not a winning value, then USER3 903 is informed that the entered value is a non-winning value for the particular promotion. Nonetheless, the web pages 925 or 947 may redirect USER3 903 via link 929 to one or more consolation accounts 933. The consolation accounts 933 may be provided with corresponding consolation prizes. One such consolation prize, for example, may be a multiplier that multiplies any funds entered into the corresponding account to increase the funds. The multiplier may be provided or otherwise hidden.

If the TOK 909 or 913 is a winning number entered into the value entry field 927 or 949, respectively, then USER3 903 is directed via respective links 935 or 951 to access respective winning accounts 937 or 951. The winning accounts 937 and 951 may already include the respective prize money intended for the winner of the particular promotional scheme. Of course, prizes other than cash prizes are contemplated, in which the winning accounts 937 and 951 may include additional information for USER3 903 to receive the prizes. For example, USER3 903 may need to supply a shipping or mailing address to receive the prizes. Online cash account cash prizes, however, are particularly convenient and advantageous. It is appreciated that the promotional system 900 provides a very convenient, hassle-free and cost effective manner of distributing prizes to winning entrants, particular cash prizes.

Alternative operation of online promotional schemes described herein are contemplated. USER3 903 may alternatively be directed via link 955 to a generic web page 957 representing any promoter 917, radio station 939 etc. The web page 957 includes either a query link 959 or a game play link 961. The query link 959 directs USER3 903 to a query program 961 in which USER3 903 enters a query response, such as any information or answers to any questions in accordance with the promotional scheme. The entered query response is compared to at least one predetermined correct query response to identify one or more winners. A winner may also be identified as the first entrant with the correct query response. Alternatively, the game play link 973 directs USER3 903 to an online interactive game program 975 or the like that he/she interacts with to determine promotion results. The game program 975 may test the skills of USER3 903 for comparison with other contestants, such as via a high score or the like. The results of the game are used to determine one or more winning contestants, such as the first winning contestant, the contestant having the highest score, etc.

In general, the promotional system 900 contemplates receiving a response by entrants or contestants or the like and determining if a response is a winning response. Entrant(s) with a winning response are provided with an online prize or reward or the like. A response may be in any desired form depending upon the particulars of the promotional scheme, such as a token comprising an alphanumeric digital value, an serial number or MSN, answer(s) to one or more queries or trivia question(s), results of a game, etc. A particularly convenient prize or reward is cash via an online cash account as described herein.

If USER3 903 is not a winner, he/she may be so informed and not further directed. Alternatively, whether USER3 903 is a winner or not, the query program 961 or the game program 975 may further direct him/her via link 963 or 977, respectively, to the promotion program 901 of the cash account system 107, which further directs the entrant to a generic web page 965. The generic web page 965 includes a results section 967 including associated links or information associated with the particular promotional scheme, such as whether the entrant is a winner or not. If USER3 903 is not a winner, then the results section 967 may direct the entrant via link 929 to a consolation account 933. Alternatively, USER3 903 may be directed via link 969 to a winning account 971 with associated prize money or the like as previously described.

It is appreciated that the promotion system 900 provides several advantages over traditional promotional schemes. The distributor desiring to conduct the promotional scheme provides a plurality of tokens, such as associated MSN serial numbers or the like, to the cash account system 107. The tokens may be according to existing numeric designations or MSNs on corresponding products such as lot number, serial numbers, barcodes, etc., currently provided on existing products. There would be no need to retrofit previous packaging with supplemental numbers so that any product previously sold or to be sold may become part of the promotion. This helps to reduce the cost of the promotion. Furthermore, the standard mechanism to retrieve prize money is via regular mail system. In the promotion system 900, the cost of the traditional mailing system and prize money delivery is entirely eliminated in favor of online access and instantaneous retrieval of prize money. In particular, if the entrant is a winner, the winner is automatically directed and supplied with an online cash account that may be used immediately for online proxy purchases in conjunction with the cash account system 107. It is further noted that the promotional system 900 can be global and accessible at any location. For example, radio broadcasts, though typically local in nature, are often rebroadcast via the Internet or the like to various remote locations across the globe. This provides automatic global access and advertising at reduced cost and complexity of operation.

As described herein, cash cards are used as a means of enabling purchase power in the virtual world on a cash basis without the requirement of credit. One benefit of the cash card system is an expanded base for e-commerce to include anyone with cash. The cash card is a prepaid Internet purchase card that enables purchases on the Internet with total access, security, and privacy. In essence, it is a means of using cash online, with all the associated benefits, while at the same time providing the versatility and security inherent in charge cards, such as credit and debit cards. Cash cards are distributed offline through distributor merchants 303, most commonly at the point of sale (POS) and over the counter. Each cash card is accepted at any online location that accepts traditional charge cards without the need for changes in e-merchant shopping carts or payment software infrastructures. The cash card is used for at least two purposes, including a means of transferring the purchase power of cash from the offline world into the virtual world, and as a co-branded offline advertising medium.

Cash cards and the underlying charge number issuing and processing system 300 benefit individuals who do not have access to credit cards, such as teenagers who legally do not have access to banking relationships. The charge number issuing and processing system 300 provides online merchants increased revenue from new e-commerce enabled markets. In addition to this, individuals concerned with online privacy and security who are at best hesitant to use their existing credit cards online, and at worst completely averse to it, comprise another significant source of potential Internet commerce revenues. The charge number issuing and processing system 300 makes cash available as a viable payment solution for online commerce, thereby globalizing its penetration and making it universal. In other words, by enabling cash transactions to take place over the Internet, the charge number issuing and processing system 300 generates revenue for distributor merchants 303 by granting access to customers who would otherwise use the service but do not currently have a way to pay for it. In addition to a direct source of revenue, each distributor merchant 303 also receives the capability for offline and targeted online advertising, direct customer relationship management portals, loyalty program tracking, and market research reports, all of which can lead to enhanced market presence, customer brand awareness, and increased revenues.

In an exemplary embodiment, the experience begins with a cash card purchase at an offline distributor merchant 303 location, such as a brick and mortar store or the like. At the point of sale, a customer requests a cash card for a specified amount. The amount may be specified in any currency denomination, such as US dollars, or in units equivalent thereto, such as 20 “units”. The customer hands cash to a clerk or cashier, who produces a cash card, swipes it through the existing POS credit/debit card reader for validation, enters the amount of the card, and gives the card to the customer. The customer activates the card at an Internet terminal or with an ordinary telephone. The distributor merchant 303 receives $20 in the register, thereby generating a temporary surplus. The funds are ultimately transferred to the cash account system 107 and/or the issuing bank 101 through the standard electronic funds transfer already in use, such as the charge settlement network 115. For example, a batch fund transfer may be conducted between the cash account system 107 and a POS processor at regular intervals, which is done automatically in one embodiment.

Once the cash card is validated by a cashier/clerk at the point of sale, the customer may use the cash card to establish a new cash account or to update an existing cash account in the account database 323 for enabling purchase transactions. Subsequently, the customer logs onto the Internet to activate the cash card and become a user of the cash account system 107. Once activated, the funds are stored in a secure passwordprotected cash account that is accessible from any terminal with an Internet connection and can be used at any online location that accepts traditional charge cards, such as Visa or MasterCard or the like. Since the funds are stored online and the cash account system 107 is primarily software driven, the risk of theft and fraud are minimized. Once a particular serial number has been used to activate or update a cash account, that same serial number can no longer be used, making the cash card itself harmless. The cash card with its corresponding card number may be utilized for offline cash and purchase transactions once activated, but only in conjunction with a valid personal identification number (PIN) in one embodiment. The PIN may be provided by the user while accessing the associated cash account. The user may select and program a PIN into a corresponding cash account at any time after activation. For offline transactions, the user (or cashier/clerk) swipes a cash card that has been associated with the user's cash account and enters a selected PIN in order to make offline purchases or cash withdrawals.

Since almost all online merchants accept Visa and/or MasterCard, the online merchant and the charge settlement system 115 immediately accepts the card number. As far as the online merchant is concerned, the user is paying with a valid credit card, and the transaction is processed exactly in the way it is with traditional charge cards. The funds are transferred from an issuing bank 101 to the distributor merchant 303 in precisely the same way as is done normally. There is therefore no integration, software, or change in online shopping cart, and the payments are effected seamlessly. Since the processor system 113 of the cash account system 107, as certified processor, is positioned within the bank-processing loop, transactions are approved only for cash accounts that have sufficient funds, eliminating the risk of insufficient funds or disputed payments.

Since funds can easily be moved between cash accounts, the cash account system 107 enables direct and convenient transfer of funds over the Internet between individuals, and thus provides an easy and fast method of payment in the rapidly developing person-to-person market space. Another primary offline use of the cash card is as an ATM card. ATMs and POS card readers with PIN functionality accept the cash card in a similar manner as a credit or debit card. In other words, any user can withdraw funds immediately from any ATM using a cash card that has been associated with his/her account and a PIN that has been chosen in advance. Thus, the cash account system 107 allows money transfer over the Internet and instantaneous offline access to the funds at any time. The fund transfer capability, coupled with the finctionality of ATM cash withdrawal, provides a convenient, direct and streamlined means of person-to-person payment.

Since cash card validation occurs through the existing financial network system, integration, such as by distributor merchants 303, is minimal. In particular, integration of cash card functionality by distributor merchants 303 does not necessitate any new hardware or software, and is financially risk-free since there is little or no integration costs or risks. The charge number issuing and processing system 300 uses the already existing charge settlement system infrastructure and therefore requires minimal integration and little or no financial commitment. There is no prepayment and therefore no inventory, all funds are transferred electronically through the EFT clearing loop using processors already in place, cards are validated at the POS using existing credit/debit card readers, and staff training is minimal. The cash account system 107 controls functionality and usage of the cash cards, so that the cash card is nothing more than plastic before POS validation and online account activation. The POS validation is executed through already existing charge settlement network mechanisms and payment is made directly via ACH using the direct POS processor already in place. The possibility of theft or fraud to the offline distributor merchant 303 is dramatically reduced, eliminating the need for inventory and providing easy and direct implementation.

Since the cash cards cannot be activated for online use until they have been validated offline, there is no prepayment to carry the cards, reducing inventory and security costs. Since each cash card is validated by the cashier at the POS by swiping it through the existing credit card reader, the only security risk is equivalent to the risk of that employee pocketing cash. The cash account system 107 provides even more security, since accounts are tracked and deactivated if a security breach is discovered, leading to at least partial recovery of funds. Since payment is not effected until the cash card is swiped and validated, the distributor merchant 303 does not pay for the cash cards until the cash is already in the register, thereby reducing or otherwise eliminating financial risk. Additionally, if one or several cash cards are stolen before they are validated, they are worthless and cannot be activated online, completely eliminating the responsibility of the distributor merchant 303 for the cash cards, so that there is little or no risk to the distributor merchant 303 for cash card distribution. Since each transaction or purchase number is unique, even if someone should break into the cash account system 107, stolen purchase numbers are useless for other purchases, dramatically increasing online merchant security even beyond the level of credit cards.

Since the cash accounts are prepaid, as far as the online merchant is concerned, there is considerably less financial risk than with traditional credit cards. In the case of credit or debit cards, issues could arise with insufficient funds, disputed charges, or fraud that would force the online merchant to absorb the loss. The cash accounts are prepaid, reducing or otherwise eliminating the possibility of insufficient funds, since if there is not enough money in the account to pay for the purchase, the cash account system 107 does not authorize a transaction. Disputed charges are also considerably less likely, since the security features and the direct authorization inherent in the cash account system 107 ensures that charges are made with full user authority. Due to its security features, encryption technology, and multiple levels of coverage, the cash account system 107 ensures that the possibility of fraud to the online merchant is reduced to a minimum. Since all numbers used for payment are uniquely determined, even should they be stolen they cannot be used for online purchases other than the one they were initially designated, eliminating the possibility of fraudulent usage and the risk to the distributor merchant 303.

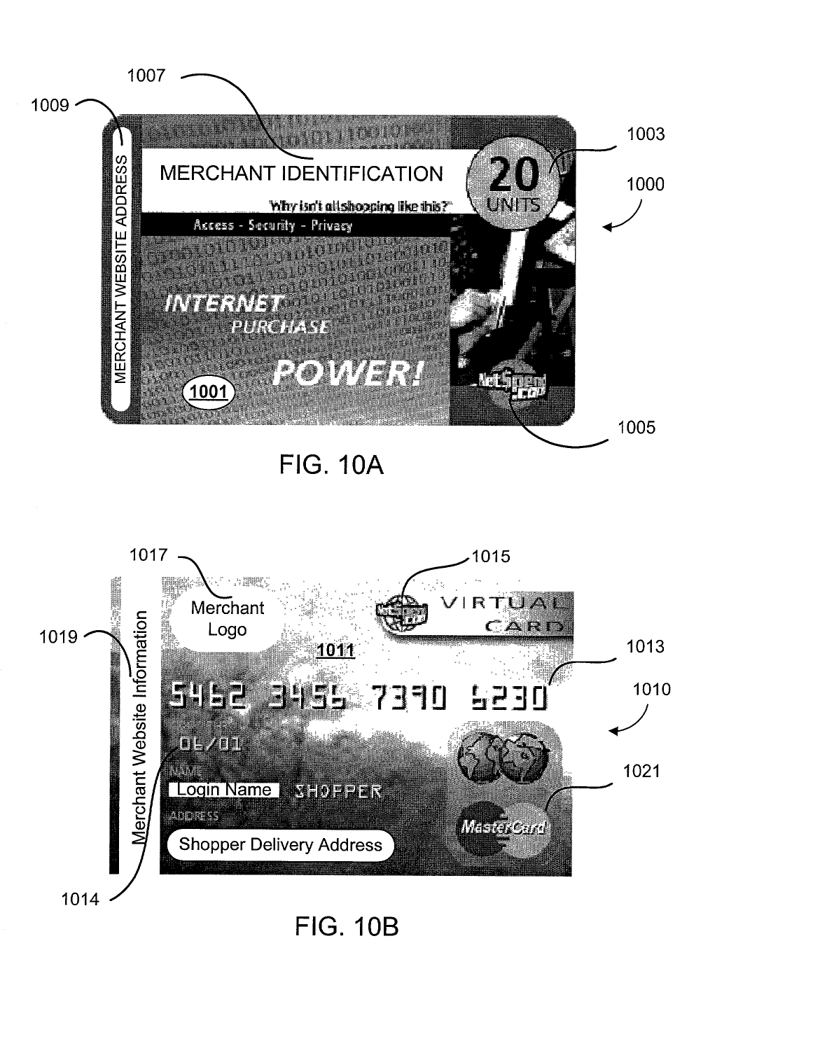

FIG. 10A is a graphic diagram of an exemplary cash card 1000 that is purchased at a distributor merchant 303. The cash card 1000 resembles a prepaid telephone card or is otherwise configured in a similar manner as a credit or debit card. It is noted, however, that the card number of the cash card 1000 is not printed or stamped on the physical card in one embodiment for enhanced security reasons, where the card number is instead provided or otherwise encrypted on a magnetic strip or the like provided on the back surface. The cash card 1000 includes a numeric unit designation 1003 or the like indicating the initial purchase value of the cash card 1000, where the units represent any currency denomination (e.g. U.S. dollars). A surface 1001 of the physical cash card 1000 provides advertising, marketing and branding opportunities. The branding information is any combination of pictures, scenes, colors, logos, slogans, trade names, symbols, expressions, etc., that are used by the distributor merchant 303 for identification or marketing. In particular, each cash card may be configured for a particular distributor merchant 303 with that merchant's advertising information provided on the surface. For example, the surface 1001 of the cash card 1000 is co-branded with a logo 1005 identifying the entity maintaining or sponsoring the cash account system 107, such as an entity “Net$pend.com”, and merchant information 1007 indicating or identifying the particular distributor merchant 303 selling the card. Other merchant information may be provided, such as a merchant website address 1009 or the like. Further, the card may be branded with trademarks or logos of a sponsoring or issuing bank or any member of the Visa or MasterCard (MC) association of banks or by Visa or MasterCard (not shown).

The co-branded cash card 1000 is essentially transferred online with cash card and cash account activation. In order to shop online, the user requests a charge number or otherwise accesses a cash account, and the cash account system 107 displays a virtual card on a web page or as a separate web page window on the user display. The virtual card is branded in a similar manner as the offline cash card 1000 and includes a purchase number retrieved from the purchase numbers 111. Again, the branding information is any combination of pictures, scenes, colors, logos, slogans, trade names, symbols, expressions, etc., that are used by the distributor merchant 303 for identification or marketing. Each time that user shops online, the virtual card is the means of payment, creating a point-of-sale advertisement for the distributor merchant 303 that sold the card that is present anytime a payment is made. In this way, a cash card bought at a distributor merchant's offline store remains with the user, even when the user shops online. This allows, in essence, advertising for the distributor merchant 303 to take place at any online or offline merchant.

FIG. 10B is diagram of an exemplary virtual card 1010, which is a graphic representation displayed on the user's monitor or screen with a graphic surface 1011 that may include similar information as the physical cash card 1000. Instead of the numeric unit designation 1003, however, the graphic surface 1011 of the virtual card 1010 includes a purchase number graphic 1013 that graphically resembles stamped or raised numbers as is common on credit cards. The purchase number graphic 1013 is the same as the actual purchase number retrieved from the purchase numbers 111 and is a valid charge number. The graphic surface 1011 of the virtual card 1010 also includes an expiration date graphic 1014 that is the same as a valid expiration date to be used in conjunction with the retrieved purchase number. The graphic surface 1011 of the virtual card 1010 may also include co-branded information, such as a logo 1015 identifying the entity maintaining or sponsoring the cash account system 107, such as the entity “Net$pend.com” associated with Netspend Corporation, a merchant logo 1017 indicating or identifying the particular distributor merchant 303 selling the card, a merchant website address 1019, etc. Further, the graphic surface 1011 of the virtual card 1010 may be branded with trademarks or logos of a sponsoring or issuing bank or any member of the Visa or MasterCard (MC) association of banks or by Visa or MasterCard, such as a MasterCard logo graphic 1021. Any other information may be included, such as the name and address of the user. The name, however, is not necessarily the actual name of the user, but instead may be the user's login name. Also, the address is optional and may be the default delivery address.

In one embodiment, virtual card mimics or otherwise resembles a corresponding physical cash card. In this manner, since the identity of the distributor merchant 303 where the user purchased the cash card and the configuration of the particular cash cards at that merchant are known, the virtual card appears as a very similar or even a duplicate representation of the cash card with the same or similar branding information. When the virtual card is displayed, however, a purchase number is retrieved and displayed on the virtual card on the user's monitor. Thus, the virtual card may be similar in appearance in many respects and yet not be identical since the virtual card may actually look more like a credit card where the purchase number is graphically represented in a similar manner as a credit card number as shown for the virtual card 1010. Also, the retrieved purchase number is not the same as the card number on the physical card. In some embodiments previously described, for example, the retrieved purchase number is a unique number that is used for one transaction and then expired. Further, even when the same virtual card is displayed for a subsequent and different transaction, a new purchase number is retrieved and displayed on the virtual card for the subsequent transaction. The look and appearance of the virtual card is still similar since the new purchase number is in the same format (same number and format of numeric characters).

In another embodiment, the virtual card includes interactive capabilities, such as a virtual button, link or meta tag or the like. The interactive virtual card prompts the user to click a button or link that prompts the transaction and account system 119 to display another web page or open a window with a new web page to any marketing information 1103. In yet another embodiment, the virtual card is displayed as a video portal where the transaction and account system 119 further transmits a video file, media file or the like that causes the user's system to display the video through the virtual card. For example, a video rental store distributor merchant 303 desires to play one or more selected movie previews and trailers of new movies available for rent to a user that purchased a cash card at that video rental store. In one embodiment, the virtual card operates as a video portal to display the video, so that the displayed video is the same size as the virtual card. The video or media file is executed automatically upon display of the virtual card, or the virtual card includes an interactive button or the like that initiates the media file upon selection.

The purchased physical cash card generates offline awareness of an online store associated with the distributor merchant 303. The self-reference of the marketing system serves to fully integrate the offline experience of the customer with online presence awareness. For example, the customer purchases a cash card offline for online use, carries the offline advertisement for the online store, uses the offline/online virtual card when shopping online, is streamed advertisements for both the offline and online stores while shopping online, and is offered promotional discounts or printable coupons that can be printed and brought back to the offline store and used for purchases. In other words, the online benefit is not removed from the offline, and both serve to reinforce each other into a unified customer experience about the distributor merchant 303.

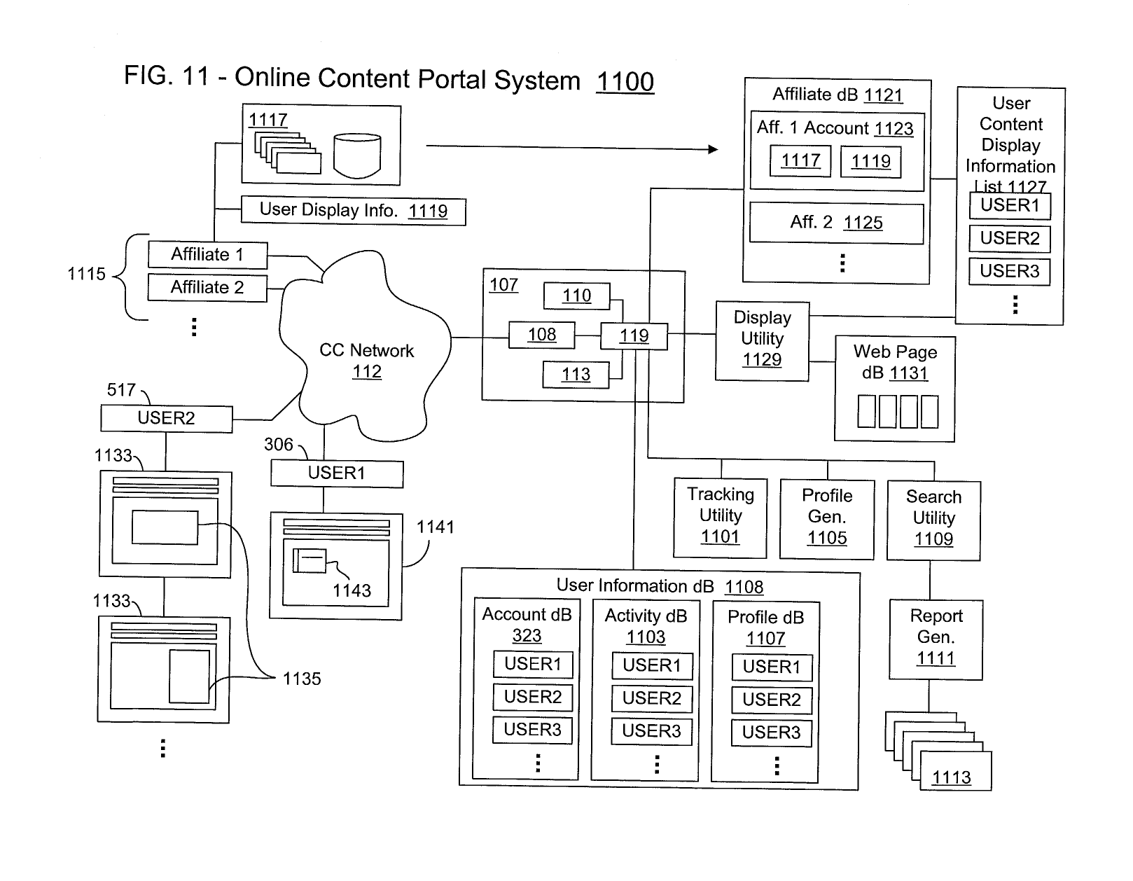

FIG. 11 is a block diagram of an exemplary online content portal system 1100 or “transdigital gateway” enabled using the cash account system 107. The online content portal system 1100 facilitates a selected or targeted method of user access for displaying any type of content, including advertising and marketing material. As described previously, the cash account system 107 generates and stores an account database 323 that includes one or more individual user accounts, shown as USER1, USER2, USER3, etc. The account database 323 is included within a user information database 1108, that further includes an activity database 1103 and a behavioral profile database 1107. The user information database 1108 may be stored in any desired manner, such as on the storage device 117. The cash account system 107 further includes a tracking utility 1101, coupled to the transaction and account system 119, that tracks online and offline information about each user, such as any combination of shopping or browsing information, e.g., where or with whom the user shops, spending information, e.g., how much they spend, merchant information, e.g., which merchants the user appears to prefer, or avoid, purchase information, e.g., what the user purchases, and amounts, etc. The tracking utility 1101 tracks and monitors online and offline user activity via the computer network communication system 108, the telephonic communication system 110 and the processor system 113. The tracking utility 1101 generates and stores the activity information into the activity database 1103.

The cash account system 107 further includes a profile generator 1105, coupled to the transaction and account system 119, that creates behavioral profiles for each of the users of the cash account system 107 and stores each profile into the profile database 1107 of the user information database 1108. The user profiles may be as detailed and specific or as general as desired. This is achieved without violating any privacy issues, however, since the cash account system 107 does not need to collect personal information. In addition, the cash account system 107 connects the online behavioral profiles with offline activity since it is known where each user makes their cash card purchases. Thus, the user profiles in the profile database 1107 includes both online and offline profile information.

The user profiles may each incorporate the account information in the account database 323 and the activity information in the activity database 1103, or includes pointers to such information. For example, rather than repeating the account balance information already stored in a user account in the accounts database 323, the profile database 1107 may optionally include a pointer or link to the account balance information. The profile generator 1105 further generates summary and aggregate information about each user, such as average account balances, frequent shopping and browsing behavioral information, etc. The cash account system 107 enables users to shop at and purchase from any third party that is configured to accept standard credit or charge account information. Such third parties include online merchants in which a valid charge number is provided to consummate the sale. Such third parties include any offline or brick and mortar merchants that accept the cash cards as debit cards as previously described. It is appreciated, therefore, that the profile database 1107 incorporates very valuable marketing information associated with any and all of the users of the cash account system 107.

The cash account system 107 further includes a search utility 1109, coupled to the transaction and account system 119, that receives one or more queries or search parameters or the like, and that conducts a search of the profile database 1107. The search utility 1109 is configured to provide any type of output that is desired by a searching entity, such as a list of users of the cash account system 107, that meet the search criterion, or a list of behavior profiles of the users. The search utility 1109 is interfaced to a report generator 1111, that generates marketing reports stored in a report database 1113 in association with a search request. The marketing reports are based on any one or more of the behavioral profiles in the profiles database 1107. The searches or marketing reports may be generalized and based on aggregate information of several or all of the behavioral profiles, or selected profiles filtered in any desired manner. The searches or marketing reports may be more specific and based on selected characteristics of the user profiles, such as selected users that shop at particular merchants or merchant types, that shop for particular goods or services, that have or otherwise maintain cash balances above a minimum threshold, etc.

The marketing reports from this research may be used to generate more successful marketing/promotional schemes that may involve various cross-promotional opportunities. Thus, cash account system 107 enables an unprecedented granularity in behavioral profiling and a link between the online/offline worlds, at the same time doing so without violating privacy concerns. The reports may optionally include information on a substantial portion or even all users or cash account members of the cash account system 107. The reports may optionally include aggregate customer information. The reports may further include various cross-sectional analyses of the data on user spending habits, amounts, items, offline purchases, etc. Since the cash account system 107 does not need to collect any personal information from the users, the data is optionally anonymous and therefore compliant with privacy demands. Since user behavioral profiles are indicative of future purchasing behavior, the reports provide a direct and discrete analysis in terms of true user knowledge. The reports may be printed or accessed directly via a secure web page, and they are available in real-time.

The search utility 1109 and report generator 1111 are available to “affiliates” of the cash account system 107. An affiliate is any business entity who desires to become affiliated with the cash account system 107 in exchange for payment, goods or services. For example, a distributor merchant 303 becomes an affiliate in exchange for selling cash cards to its customers, who then become users of the cash account system 107. A business entity may become an affiliate by conducting a promotional, marketing or advertising scheme or the like that informs its users, customers, potential customers or the general public about the cash account system 107 in such a manner that brings potential users to the cash account system 107. An affiliate may be any introducer, merchant or vendor, including distributors, e-merchants conducting online sales and transactions, traditional brick and mortar merchants, etc., that may have an interest in using or accessing the online content portal system 1100 available through the cash account system 107 to its users. A business entity that is not already an affiliate may become an affiliate through one or more affiliate programs or the like, where the potential affiliate applies and signs an appropriate agreement and pays any associated fees depending upon the level of service desired.

As shown, one or more affiliates 1115 are optionally coupled to the computer communications network 112 in a similar manner as previously described, such as via a computer or Internet access terminal. The affiliates 1115 may access the search utility 1109 and/or the report generator 1111 via online means, such as employing a browser or the like, and receive real time search output or reports. It is noted, however, the affiliates 1115 need not have online access to benefit from the online content portal system 1100. In alternative embodiments, for example, an affiliate 1115 may submit a batch search request or query, such as through email or regular mail or the like, and receive the search reports in a similar manner. In any event, one or more such affiliates 1115 use the search utility 1109 and/or the report generator 1111 to identify one or more users of the cash account system 107 that meet the search criterion. Search criterion may include, for example, those users within a certain locality (such as employing the locality information 335), those users having at least a minimum account balance, those users that maintain at least a minimum account balance average, those users who shop and/or purchase at predetermined merchants and/or for certain types of goods or services, etc. It is noted that any type of search criterion available for the information stored within the user information database 1108 is contemplated herein.

One or more of the affiliates 1115 have affiliate content 1117 that they desire to be provided and displayed to selected users when logged onto the cash account system 107. The affiliate content 1117 is in any type of format known or otherwise, such as data and/or text files, web pages, graphic files, audio files, video files, etc., and includes any type of content, such as marketing content, advertising information, branding information, discount information, promotions and promotional information, informational messages, etc., and is configured for display to the selected user(s) in any desired manner, such as static web pages, dynamic web pages, interactive web pages, streaming advertising, banner advertising, printable coupons, etc. The affiliates 1115 with affiliate content 1117 may also provide user display information 1119, which identifies those users that are to receive certain types of affiliate content 1117. For example, the user display information 1119 may comprise a list of users that are to receive the corresponding affiliate content 1117. Although the user display information 1119 may, in some cases, indicate all of the users of the cash account system 107, the affiliate 1115 may employ the search utility 1109 and/or the report generator 1111 to identify selected users to receive the affiliate content 1117. It is noted that an affiliate 1115 may have different groups of affiliate content 1117 intended for different groups of users, which is contemplated herein. For example, the affiliate 1117 may have content A for userlist 1, content B for userlist 2, etc., where the affiliate content 1117 includes each of the content groups (A, B, etc.) and where the user display information 1119 includes the userlists and links to the associated affiliate content.

The affiliates 1115 send the affiliate content 1117 and the user display information 1119 to the cash account system 107 in any desired manner, such as on a storage media (e.g. tape, magnetic media, optical media, CD ROM, floppy disks, hard drive, zip drive, etc.) via regular mail, courier service, overnight mail, or may be sent in digital format over the computer communications network 112 in email format. The cash account system 107 includes an affiliate account database 1121, coupled to and controlled by the transaction and account system 119, that stores the affiliate content 1117 and the user display information 1119, if any, for each of the affiliates 1115. A first affiliate, referred to as affiliate 1, for example, forwards its affiliate content 1117 and user display information 1119 to the cash account system 107 for storage in an affiliate account 1123 associated with the first affiliate 1. A similar affiliate account 1125 is provided for a second affiliate 2 for storing similar type information. In one embodiment, one or more affiliates 1115 are provided online access to log on and access/manage their affiliate account in a similar manner as described herein relative to users. The transaction and account system 119 provides content management capabilities such as transfer of content graphic files or the like (e.g., TIF, GIF, JPG, etc.) with links to an instruction page, specifications page, and other pages with delete, upload, and replace buttons that enables the affiliates 1115 to manage their accounts and content information as desired. In such online embodiments, the affiliates 1115 are able to upload their affiliate content and related information online and to manage their accounts at any time and at almost any convenient location with access to the Internet. The affiliate database 1121 is stored on any desired storage media, such as the storage device 117 or the like.

The transaction and account system 119, or a related database utility, retrieves the affiliate content 1117 and user display information 1119 from each affiliate account and that parses the content and user information into separate content information files for each user and generates a user content display information list 1127. The cash account system 107 further includes a display utility 1129, coupled to the transaction and account system 119, that retrieves display information from the user content display information list 1127 and a web page database 1131 or the like to display the appropriate information to each user when logged onto their cash accounts. The web page database 1131 stores a plurality of static and programmable or interactive web pages for transmission and display to users accessing their accounts. The web page database 1131 stores, for example, template web pages that are retrieved and programmed with more specific information (e.g., from the user's cash account within the accounts database 323) for transmission to and display by each user that logs on. The display utility 1129 further modifies the display information with affiliate content from the user content display information list 1127, and then sends the final display information to the users while accessing their accounts.

USER1 306 and USER2 517 are shown accessing their accounts via the computer communications network 112 and the cash account system 107. Assuming an affiliate 1115, such as affiliate 1, has selected USER2 517 to display content, such content is provided in the user content display information list 1127 associated with USER2. The display utility 1129 retrieves the affiliate content 1117 selected by the affiliate 1 for display to USER2 and incorporates the information into the appropriate web pages that are sent to USER2. USER2 access the web site of the cash account system 107 and retrieves and displays one or more web pages 1133. One or more of the web pages 1133 includes display information 1135, such as any combination of graphics, text, windows, interactive material, icons, etc., that incorporates or is otherwise based on the affiliate content 1117 from the affiliate 1.

The online content portal system 1100 contemplates other types of affiliate content that is not necessarily stored in the user content display information list 1127, but that is associated with a user. For example, it is known that USER1 306 purchased a cash card 201 from the distributor merchant PQR. When USER1 is logged onto their cash account, the cash account system 107 displays a virtual card 1143 within a web page 1141 to USER1. The virtual card 1143 may be displayed immediately or after USER1 requests a charge number, such as during an online purchase transaction. The virtual card 1143 may be in any format, such as resembling the virtual card 1010. The virtual card 1143 is another vehicle for an affiliate to display content, such as marketing information or the like, to a user. It is particularly advantageous for a distributor merchant 303 to display marketing material to a customer that has physically entered their store and purchased a cash card.

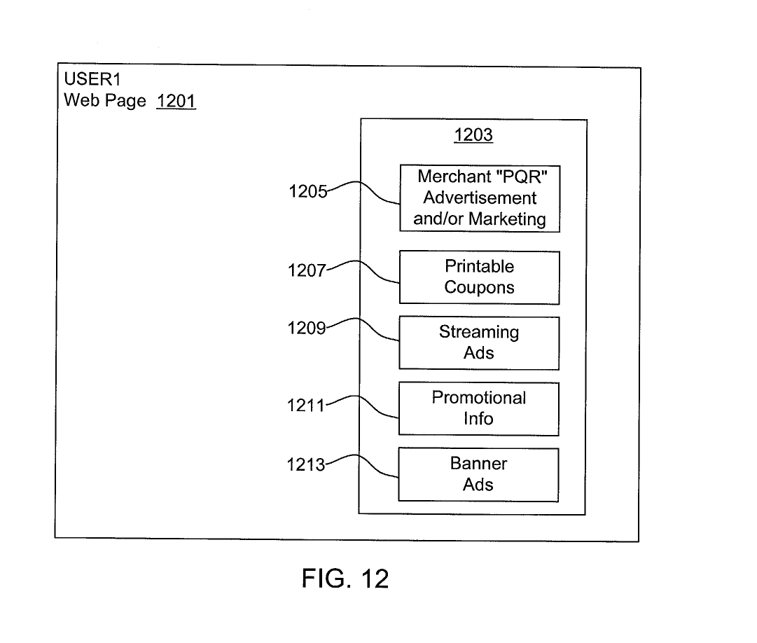

FIG. 12 is a screen shot of an exemplary and simplified web page 1201 that appears during an online session when a user, such as USER1 306, is logged into the cash account system 107 and the USER1 account 325. The web page 1201 includes an exemplary content portal section 1203 for sending the affiliate content 1117 to USER1 306 when accessing his or her account. The content portal section 1203 may include any type of suitable display content from one or more affiliates of the cash account system 107. Although only a single web page 1201 is shown for purposes of illustration, it is appreciated that any number or all web pages displayed to a user while accessing a corresponding cash account may include a similar content portal section. Each content portal section may be any size or shape and may be placed at any convenient location of one or more web pages for displaying affiliate content to the user. For example, content portal section 1203 may be of a particular size, shape and location within each web page for displaying affiliate content to the user if desired.

The affiliate display content may comprise advertisements and/or marketing information intended to inform the user about the affiliate or its goods or services. For example, the merchant PQR from which the cash card 201 was purchased may post advertisement and/or market information 1205 within the content portal section 1203 of the web page 1201. Furthermore, other affiliates may post affiliate content within the content portal section 1203, such as printable coupons 1207, streaming advertisements 1209, promotional information 1211, banner advertisements 1213, etc.

It is noted that affiliate content displayed to the user may include branding information of the sponsoring affiliate, such as a logo or the like including a trade name and any other desired information. In this manner, the web page 1201 is used as a transdigital gateway or content portal to enable display of advertising, marketing, or any other type of information to one or more selected users of the cash account system 107. The user(s) are selected in any manner, such as associated with a particular locality, county, city, or other geographic area, or based on results of a search using the search utility 1109 or a market research report using the report generator 1111.

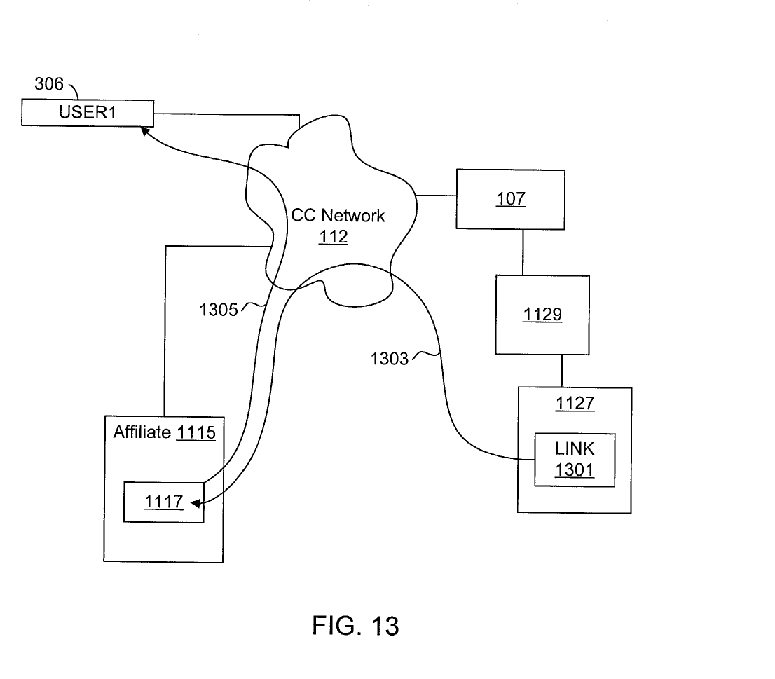

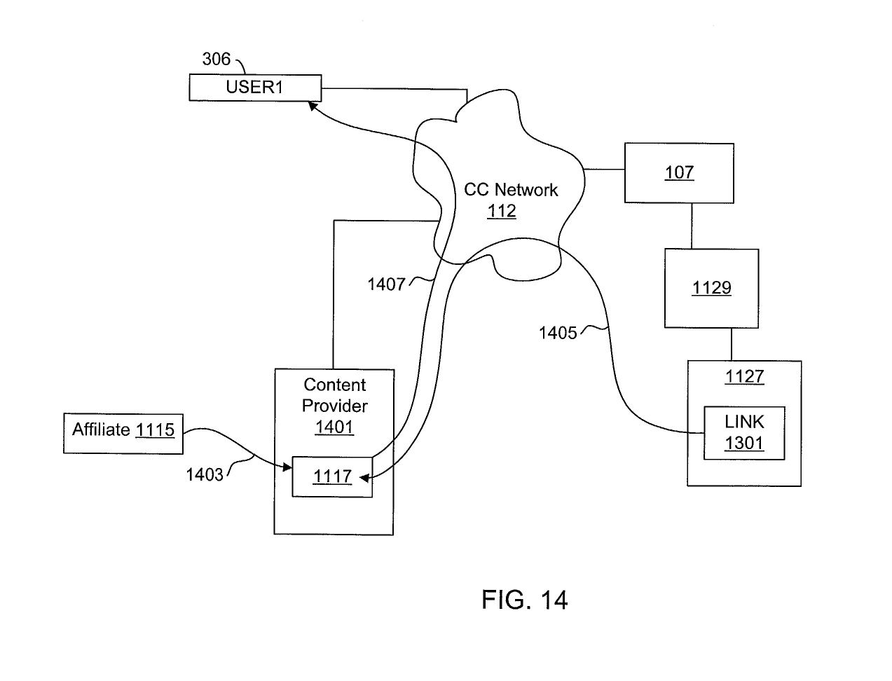

The online content portal system 1100 illustrated in FIG. 11 may be sufficient for a certain limited number of affiliates 1115 and users, but the overall system may not have the desired processing capacity to handle a large number of interfaces. In one embodiment, for example, the processing capacity of the online cash account system 107 may be limited and unable to send respective affiliate content 1117 to all of the users that are logged on at peak operating periods. The affiliate content 1117 may include, for example, streaming content, such as streaming video or the like, that may task the servers at the online cash account system 107 beyond intended capacity. Furthermore, it may be deemed undesirable for the online cash account system 107 to conduct database searching, or at least to conduct all database searching for all queries. FIGS. 13-16 illustrate alternative embodiments that may be employed, alone or in combination, for offloading one or more processing tasks to the affiliates 1115 and/or third parties.

FIG. 13 is a block diagram illustrating an alternative embodiment in which the affiliate content 1117 is provided directly to a user, such as USER1 306, from a particular affiliate 1115. In this case, the display utility 1129 does not retrieve the affiliate content 1117 from the user content display information list 1127, but instead retrieves or inserts link information, shown as a LINK 1301, to the affiliate content 1117 located on the servers of the affiliate 1115. The LINK 1301 is in any convenient format, such as a hyperlink or pointer or the like, that indicates the location of the affiliate content 1117 as indicated by arrow 1403. In this manner, the online cash account system 107 serves to direct the user's browser to the affiliate content 1117 and acts like a “broker” of the content. The affiliate content 1117 is thus provided directly from the affiliate 1115 via the computer communications network 112 as shown by arrow 1305 rather than from the online cash account system 107. Such indirect linking of the affiliate content 1117 serves to offload processing to the affiliate's servers and reduce the processing performed by the servers of the online cash account system 107.

FIG. 14 is a block diagram illustrating another alternative embodiment in which the affiliate content 1117 is provided directly to a user from a third party content provider 1401 rather than from the particular affiliate 1115. The affiliate 1115 may not be configured to deliver the affiliate content 1117, so that the affiliate content 1117 is delivered and stored on the servers of the content provider 1401 as shown by arrow 1403. Configuration and operation is similar, except that the LINK 1301 points to the affiliate content 1117 at the content provider 1401 rather than the affiliate 1115, as shown by arrow 1505. The content provider 1401 is configured in the appropriate manner to deliver the affiliate content 1117 to the user, such as USER1 306, via the computer communications network 112 as shown by arrow 1407.

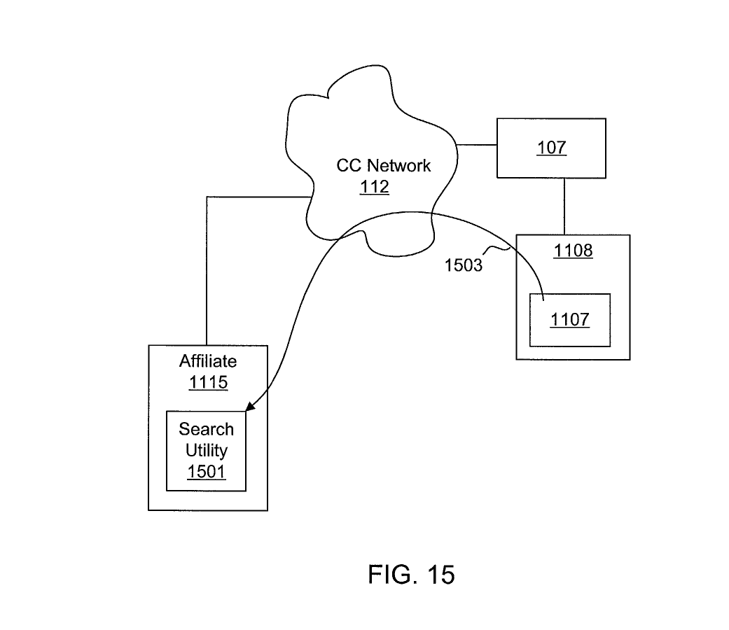

FIG. 15 is a block diagram illustrating another alternative embodiment in which the affiliate 1115 (or a third party provider) includes an appropriate search program or utility 1501 to offload some or all of the database search-related processing conducted by the online cash account system 107. The online cash account system 107 may or may not have the search utility 1109 or the report generator 1111 in this configuration. Instead, any selected portion or the entire contents of the user information database 1108, such as all or a selected portion of the behavioral profile database 1107, is downloaded to the affiliate 1115 as indicated by arrow 1503. The transaction and account system 119 and/or the tracking utility 1101 may be configured to access and download all or selected portions of the user information database 1108 in response to an affiliate request. The composition of the downloaded information is according to a predetermined format that is either directly compatible with, or that may be imported or configured for use by, the search utility 1501. The search utility 1501 may be provided by the online cash account system 107 or may comprise any acceptable third party software.

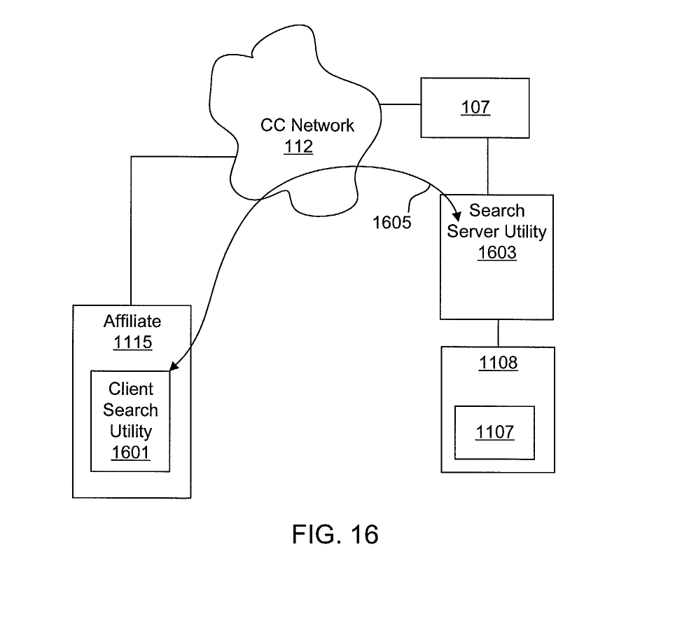

FIG. 16 is a block diagram illustrating another alternative embodiment in which the affiliate 1115 (or a third party provider) includes a client search utility 1601 to offload some or all of the database search-related processing conducted by the online cash account system 107. In this case, the client search utility 1601 is client software or is configured as a browser plug-in or the like that cooperates with a corresponding search server utility 1603 at the online cash account system 107 as indicated by arrow 1705. In one embodiment, the search server utility 1603 may be configured to conduct a portion or all of the search query submitted by the client search utility 1601. Alternatively, the search server utility 1603 retrieves any portion (or all) of the behavioral profile database 1107 selected by the client search utility 1601 and delivers the selected content to the client search utility 1601 at the affiliate 1115 via the computer communications network 112.

It is appreciated that the online content portal system 1100 provides a powerful business advantage to both the cash account system 107 and affiliates 1115. Distributor merchants 303, for example, may have little or no incentive to distribute the cash cards 305 on behalf of the cash account system 107 without an incentive or motivational scheme. Examples of alternative schemes include a premium offered at the POS transaction or a discount offered to distributors. In the premium scheme, each cash card is sold at a premium, such as, for example, a $10 card sold for $12 or the like. This premium technique has proved disfavored by consumers who would rather receive $10 value for $10 spent. In the discount scheme, the online merchants that accept payments via the cash card offer a discount on goods or services to obtain traffic that might not otherwise have been realized. The discount is ultimately provided back to the distributor. This discount scheme, however, is very limited in that the cash card could only be utilized to purchase from participating merchants. Instead, the cash account system 107 provides a prepaid cash account that enables purchases at any online merchant. Further, the cash account system 107 provides the online content portal system 1100 to provide substantial business incentive to distributors, including targeted advertising and marketing.

It is appreciated that the online content portal system 1100 provides any one or more affiliates, including distributor merchants and the like, with a direct portal or link with one or more selected users. Every time a user accesses his/her cash account, such as to check available funds, send money to someone else, or check account history, the user is exposed to a message or other content from one or more affiliates. The affiliate content may be localized information, such as from particular stores of a distributor merchant 303, even if it is a regionally defined message, and may contain information about the particular distributor merchant store that sold that cash card. Such enables a means of customer relationship management and continued contact. The affiliate content may alternatively have little or no local significance, but may be targeted to potential online customers of an online merchant. The affiliate content may have different levels of prominence, positioning and exposure to increase user awareness of products, brands, and merchant locations. The affiliate content may be used to disseminate promotional information, distribute printable coupons online to existing customers, or to develop other means of bringing users back to an online merchant or into an offline distributor merchant store where they can contribute to the increased revenues.

Many marketing benefits are enabled by the unique position of the cash account system 107 as an Internet cash payment solution. The cash account system 107 provides continuing repeated contact with online users, both for account management purposes and at the point-of-sale. Since each user interacts with the cash account system 107 in some way when shopping online, such as by logging into a cash account established at the cash account system 107, it is possible to display marketing information directly to the user every time they shop online that may relate to an affiliate or even a merchant's offline locations, even down to the level of the specific store where a cash card was purchased. The affiliate content may be an advertisement or an interactive message that is directed to the user based on their spending profile, previous online behavior, location, etc., and can include content that is customized for that user's individual circumstances. The content is present at the point-of-sale, and provides an innovative means of advertising directly to customers that are established offline customers.

In one embodiment, the advertisements and messaging portals are spread virally to encourage widespread dissemination. In particular, the cash account system 107 provides an efficient means of making person-to-person payments. In one embodiment, the cash account system 107 further provides rewards for transferring money to friends and encouraging them to use the cash account system 107, not only spreading whatever advertisements the original account had, but also encouraging, such as through similar incentives, return visits to the site to shop online and be exposed to them.

As described previously, the cash card associated with a cash account can be used to make offline purchase payments. One benefit of this to the offline distributor merchant 303 is in terms of loyalty programs that are tracked by the cash account system 107 directly and which integrates offline and online rewards through a unified payment solution. This allows, essentially, the control and convenience in terms of rewards that have been associated with credit cards are now applied to cash customers. The delivery of the reward perks can be effectuated at the offline point of sale, as a credit to a cash account, or as a printable coupon that can be brought into a physical store and redeemed, increasing customer loyalty and offline venue traffic.

In one embodiment, the cash account system 107 may provide additional incentives to use the cash card offline in the form of reward points, especially a distributor merchant-specific cash card at the distributor merchant's store(s). Since all transactions are authorized via the processor system 113 of the cash account system 107, the cash account system 107 tracks user spending and may connect offline and online shopping with special rewards. In this way, the same customer incentive benefit programs are provided to cash customers as are already provided to users using credit cards. The use of cash cards for transactions provides the additional benefit in that privacy and personal security is not an issue and is preserved. In either case, the users benefit regardless of whether they uses their associated cash account online or offline.

The offline distributor merchant 303 store can generate numerous ways of maintaining customer loyalty through the online content portal system 1100. This can be done through online delivery of printable coupons, information about promotions underway in particular stores or regions that can be directed to users who live/shop in that region, or through encouraging users to return to the store to claim various rewards for shopping online. In addition to this, as already mentioned, the cash account system 107 tracks offline and online shopping and tracks loyalty directly, providing users incentive to return to the offline store (i.e. the distributor merchant's rewards keep them coming back to the offline store rather than some competitor store for purchases).

The cash account system 107 infrastructure allows for direct delivery of promotional giveaways over the airwaves. The cash account system 107 is beneficial for the radio stations since it streamlines the promotions process and at the same time generates real-time data on promotional participation. In general, only one person who participates in the promotion wins the predetermined funds. The remaining participants receive complimentary cash accounts which are given an initial nominal or zero value, but which also have a multiplier (hidden or disclosed) by which the first amount charged into the cash account is increased. This provides an incentive for users to recharge their accounts. Distributor merchant 303 benefit in that the list of distributor merchant locations where potential users can purchase cash cards is announced over the radio.

In addition to online giveaways, the cash account system 107 also enables remote locations giveaways of promotional cards that work in a similar manner, in that there are only several winners, but there are many promotional cash accounts with incentive to recharge accounts. In one embodiment, the promotional cash cards are branded on the front with the promotional partner. Additionally, a smaller branded advertisement may be provided on the back of the cash cards for offline distributor merchants 303. Thus, every individual who receives a promotional cash card is made aware of the offline distributor merchant 303 location, again providing essentially an offline advertising medium for the distributor merchants 303.

Although a system and method according to the present invention has been described in connection with one or more embodiments including preferred embodiment(s), it is not intended to be limited to the specific form set forth herein, but on the contrary, it is intended to cover such alternatives, modifications, and equivalents, as can be reasonably included within the spirit and scope of the invention as defined by the appended claims.

1. A method of providing an online content portal for sending affiliate content to at least one user of an online account system via an electronic communications network, comprising:
providing a corresponding one of a plurality of online cash accounts for each of a plurality of users of the online account system;
enabling each of the plurality of users to conduct purchase transactions with third parties via the electronic communications network using funds in corresponding online cash accounts, the online account system configured to provide valid charge numbers acceptable to the third parties to consummate the purchase transactions;
monitoring activity of users employing corresponding online cash accounts, the activity including shopping and purchase behavior of the users with the third parties;
storing a user information database that includes account and activity information of each of the plurality of users; and
providing a content portal with at least one online cash account for sending affiliate content to corresponding one or more users.

2. The method of claim 1, further comprising maintaining confidentiality of personal information of at least one of the users.

3. The method of claim 1, further comprising:
providing the affiliate content to at least one selected user via corresponding content portals.

4. The method of claim 3, further comprising:
incorporating a link into the content portal indicative of the location of the affiliate content; and
providing, from the indicated location, the affiliate content to the corresponding one or more users.

5. The method of claim 3, the affiliate comprising a distributor of cash cards, further comprising:
providing a cash card that may be used by a user to establish or replenish an online cash account via the electronic communications network; and
distributing, by the distributor, the cash card.

6. The method of claim 5, further comprising:
enabling the cash card for offline financial transactions using funds in a corresponding online cash account;
said monitoring including tracking online and offline activity of the at least one user; and
storing tracked activity information in the user information database.

7. The method of claim 5, the distributor comprising a promoter, further comprising:
linking the promoter with the cash card;
distributing, by the promoter, the cash card for free in association with a promotional scheme; and
establishing a promotional online cash account for a user receiving the cash card.

8. The method of claim 3, the affiliate comprising a distributor merchant that distributes cash cards, further comprising:
providing a cash card that incorporates a corresponding serial number that may be used by a user to establish a new online cash account or replenish an existing online cash account via the electronic communications network; and
offering, by the distributor merchant, the cash card for sale.

9. The method of claim 8, further comprising:
linking an online cash account with a purchased cash card;
determining locality information of the distributor merchant that sold the cash card; and
storing the locality information in the user information database.

10. The method of claim 8, further comprising:
selling, by the distributor merchant, the cash card;
associating the distributor merchant with an online cash account that corresponds to the cash card that was sold; and
sending, by the distributor merchant via the online account system, affiliate content to a user that purchased the cash card via a content portal of the associated online cash account.

11. The method of claim 10, further comprising:
said sending affiliate content comprising sending advertising content and the like intended to provide incentive to the user to return to the distributor merchant.

12. The method of claim 8, further comprising:
validating a purchased cash card via a charge settlement network; and
identifying the distributor merchant via the charge settlement network.

13. The method of claim 8, further comprising:
providing, on a surface of the cash card, branding information associated with the distributor merchant.

14. The method of claim 8, further comprising:
selling, by the distributor merchant, the cash card;
associating the distributor merchant with an online cash account that corresponds to the cash card that was sold; and
said providing a content portal including displaying, to a user that purchased the cash card, a virtual card with brand information of the distributor merchant while the user accesses the associated online cash account.

15. The method of claim 3, further comprising:
receiving at least one token from an affiliate;
publishing, by the affiliate, the at least one token;
detecting access by an existing or potential user of the online account system that identifies the affiliate and a token; and
linking the user with an online cash account associated with the affiliate.

16. The method of claim 15, wherein said publishing comprises printing or announcing the token via a public media.

17. The method of claim 16, wherein said publishing comprises printing the token as an affiliate serial number on a product or in association with a service of the affiliate.

18. The method of claim 3, further comprising:
detecting a user accessing the online account system via a website associated with the affiliate; and
receiving affiliate identification information in conjunction with the user access.

19. The method of claim 3, further comprising:
searching, by an affiliate, one or more cash accounts employing the user information database; and
enabling affiliate content to be provided for display to at least one selected user via a content portal of a corresponding online cash account.

20. The method of claim 19, further comprising downloading information, by the affiliate, from the user information database.

21. The method of claim 19, further comprising:
receiving a search request from the affiliate; and
providing a list including at least one cash account in accordance with the affiliate search request.

22. The method of claim 19, further comprising:
receiving a search request from the affiliate; and
providing a profile list including at least one user behavioral profile in accordance with the affiliate search request.

23. The method of claim 19, further comprising:
receiving a search request from the affiliate; and
generating a research report based on aggregate profile information of a plurality of users in accordance with the affiliate search request.

24. The method of claim 19, wherein the affiliate content includes at least one of advertising information, marketing information branding information, discount information, coupon information and promotional information.

25. The method of claim 3, further comprising:
associating at least one of the plurality of users with the affiliate; and
displaying associated users a virtual card with a valid charge number and brand information of the affiliate.

26. The method of claim 25, wherein the displaying comprises displaying a virtual card with interactive capabilities.

27. The method of claim 25, further comprising:
said displaying comprises displaying a virtual card as a video portal; and
displaying a video through the virtual credit card video portal.

28. The method of claim 1, further comprising:
processing, by the online account system, user purchase transactions via a charge settlement network.

29. An online content portal system for displaying content to selected users via a computer communications network, comprising:
a computer network communication system that interfaces and enables communications via the computer communications network;
a memory, coupled to the transaction and account system, that stores a user information database including shopping and purchase activity and online cash account information;
a transaction and account system, interfaced to the computer network communication system and the memory, that facilitates purchase transactions by providing valid charge numbers acceptable to third parties for consummating purchase transactions and that maintains a plurality of online cash accounts in the memory;
a tracking utility, interfaced to the computer network communication system and the memory, that monitors shopping and purchase activity associated with each of the plurality of online cash accounts and that updates and maintains the user information database; and
a display utility, coupled to the transaction and account system, that enables access to affiliate content for display via selected online cash accounts when the selected online cash accounts are accessed via the computer communications network.

30. The online content portal system of claim 29, further comprising:
a search utility, interfaced to the transaction and account system and the memory, that is configured to receive user information requests and to provide content from the user information database in response to the request.

31. The online content portal system of claim 30, wherein the search utility outputs a list of online cash accounts that meet a search request.

32. The online content portal system of claim 30, wherein the search utility outputs a list of user profiles that meet a search request.

33. The online content portal system of claim 29, further comprising:
a profile generator, coupled to the transaction and account system and the memory, that generates user behavioral profiles based on shopping and purchase activity and online cash account information.

34. The online content portal system of claim 33, wherein the profile generator maintains a profile database that stores a plurality of user behavioral profiles.

35. The online content portal system of claim 34, further comprising:
a search utility, interfaced to the transaction and account system and the memory, that is configured to receive queries, to search the profile database, and to select online cash accounts that meet each query.

36. The online content portal system of claim 35, wherein the search utility outputs a list of online cash accounts that meet a query.

37. The online content portal system of claim 36, wherein the search utility outputs a list of user behavioral profiles that meet a query.

38. The online content portal system of claim 35, further comprising:
a report generator, interfaced to the search utility, that is configured to generate marketing reports based on user information in the user information database.

39. The online content portal system of claim 38, wherein the marketing reports are based on user behavioral profiles.

40. The online content portal system of claim 38, wherein the marketing reports are based on aggregate information of a plurality of user behavioral profiles.

41. The online content portal system of claim 38, wherein the marketing reports are stored in a report database.

42. The online content portal system of claim 29, wherein the tracking utility is configured to download information from the user information database in response to a user information request by an affiliate.

43. The online content portal system of claim 29, wherein the transaction and account system is configured to download information from the user information database in response to a user information request by an affiliate.

44. The online content portal system of claim 29, further comprising:
a server search utility that is configured to cooperate with a client utility via the computer communications network to download information from the user information database.

45. The online content portal system of claim 29, further comprising:
a user content display information list that identifies affiliate content associated with each online cash account; and
the display utility configured to provide a location link to the affiliate content indicating a location via the computer communications network.

46. The online content portal system of claim 29, further comprising:
the memory further storing an affiliate database including affiliate content from at least one affiliate;
a user content display information list that lists affiliate content associated with each online cash account; and
the transaction and account system configured to parse affiliate content from the affiliate database for each online cash account.

47. The online content portal system of claim 46, further comprising:
a web page database that stores a plurality of template and predetermined web page information; and
the display utility operating to retrieve selected web pages from the web page database and to populate template web pages with affiliate content from the user content display information list.
